(19) United States
(12) Patent Application Publication
(10) Pub. No.: US 2014/0319438 A1
(43) Pub. Date: Oct. 30, 2014

(54) TRANSPORT CART

(71) Applicant: Red Devil Equipment Co., Plymouth, MN (US)

(72) Inventors: Stephen J. Carlson, Shorewood, MN (US); Thomas Midas, Oak Park Heights, MN (US); Jude Burgoyne, Hopkins, MN (US)

(73) Assignee: Red Devil Equipment Co., Plymouth, MN (US)

(21) Appl. No.: 14/056,587

(22) Filed: Oct. 17, 2013

Related U.S. Application Data
(63) Continuation-in-part of application No. 13/974,539, filed on Aug. 23, 2013, now abandoned.
(60) Provisional application No. 61/817,464, filed on Apr. 30, 2013.

(51) Int. Cl. B62B 3/02

(52) U.S. Cl. CPC B62B 3/02
USPC 254/2 R

(57) ABSTRACT

Carts for lifting, transporting and lowering an item, such as a bucket. The carts are particularly suited for lifting, moving, and lowering 5-gallon buckets. The cart includes a lifting system that can raises and lowers the item by engaging its sidewalls. The lifting system includes an item engagement feature and a position adjustment system.

### RELATED APPLICATION

This application claims the benefit of U.S. application Ser. No. 13/974,539 filed Aug. 23, 2013 and titled TRANSPORT CART and of U.S. Provisional Application No. 61/817,464 filed Apr. 30, 2013 and titled TRANSPORT CART, the entire contents of which are incorporated herein by reference for all purposes.

### FIELD OF THE INVENTION

This application is directed to a cart, dolly or hand truck for transporting an item. More particularly, this application is directed to a cart, dolly or hand truck for transporting and lifting an item such as bucket.

### BACKGROUND

Carts, dollies and hand trucks are very useful for moving items that are heavy and/or cumbersome. However, many cart designs have a number of disadvantages. For example, for particularly heavy items, the mere action of placing the item on the support platform of the cart may be difficult. Similarly, it may be difficult to remove a particularly heavy item from the support platform after it has been moved to the desired location. Depending on the desired final location of the item, moving the item to its final location may still require manually lifting the item. This is particularly true for elevated final locations, such as on a shelf or ledge.

It would therefore be advantageous to provide a cart, dolly or hand truck that is particularly well adapted to moving items, such as containers, including lifting and lowering those items as desired.

### SUMMARY

The present invention addresses the aforementioned need by providing a cart for lifting, moving and lowering an item, such as a bucket. The cart of this disclosure includes an engagement mechanism configured to engage the container being lifted by either or both of its sidewall and an outwardly extending circumferential flange on a sidewall rather than its bottom surface; the cart may additionally include a surface to lift the container by its bottom surface. The cart of this disclosure also includes a vertical position adjustment mechanism, to lift and lower the item.

In any of the methods of this disclosure, the bucket to be picked up may be located on the same surface as the wheeled cart, on a surface even with the surface on which the wheeled cart is, or on a surface elevated in relation to the wheeled cart. Additionally or alternately, the bucket may be deposited on the same surface as the wheeled cart, on a surface even with the surface on which the wheeled cart is, or on a surface elevated in relation to the wheeled cart, such as a pallet, bench or shelf, without requiring lifting by the user.

The above summary of the various embodiments of the disclosure is not intended to describe each illustrated embodiment or every implementation of the disclosure. These and various other features and advantages will be apparent from a reading of the following detailed description.

### BRIEF DESCRIPTION OF THE DRAWINGS

The invention may be understood in consideration of the following detailed description of various embodiments of the disclosure in connection with the accompanying drawings, in which:

FIG. 1A is a perspective view, FIG. 1B is a side elevational view, and FIG. 1C is a front elevational view of a cart according to this disclosure supporting two buckets, the cart in a first position.

FIG. 2 is a side elevational view of the cart of FIGS. 1A-1C supporting two buckets, the cart in a second position.

FIGS. 3 and 4 are top perspective views of the cart supporting two buckets.

FIG. 5 is a cross-sectional view of the cart and buckets taken along line A-A of FIG. 4.

FIG. 6 is a cross-sectional view of a first foot lever of the cart, as taken along line A-A of FIG. 4.

FIG. 7 is a cross-sectional view of a second foot lever of the cart, as taken along line A-A of FIG. 4.

FIG. 8 is a perspective view of a portion of the cart, particularly the frame, showing the elevation adjustment mechanism in a raised position.

FIG. 9 is a perspective view of a portion of the cart, particularly the frame, showing the elevation adjustment mechanism in a lowered position with the release lever depressed.

FIG. 10 is a perspective view of a portion of the elevation adjustment mechanism, including a cover thereon, in a lowered position.

FIG. 11 is side elevational view of a portion of the cart, particularly the handle and release lever.

FIG. 12 is a rear elevational view of a portion of the cart, particularly the handle, release lever, and the elevation adjustment mechanism.

FIG. 13 is a top plan view of a portion of the cart, particularly the bucket engagement feature and the elevation adjustment mechanism.

FIG. 14 is a side elevational view of the cart of FIGS. 1A-1C supporting two buckets, the cart in a third position.

FIG. 15 is a perspective view of a portion of the cart, particularly the frame, wheels and brake assembly.

FIG. 16 is a front elevational view of a portion of the cart, particularly the wheels and brake assembly.

FIGS. 17A and 17B are perspective views of a portion of the cart, particularly the mechanism for moving the bucket engagement feature.

FIG. 18 is a side elevational view of the cart elevating two buckets from off of a pallet.

FIG. 19A is a perspective view, FIG. 19B is a side elevational view, and FIG. 19C is a rear elevational view of a battery-powered cart according to this disclosure, the cart supporting two buckets.

FIG. 20 is a perspective view of a portion of the cart of FIGS. 19A-19C, particularly, the control panel mounted proximate the cart handle.

FIG. 21 is a side cross-sectional view of the battery control panel and cart handle.

FIG. 22 is a bottom cross-sectional view of the battery control panel and handle.

FIG. 23 is a perspective view of an embodiment of a support tray positioned in a first, operational position.

FIG. 24 is a perspective view of the tray of FIG. 23 in a second position.

FIG. 25 is a perspective view of an embodiment of an adjustable item engagement feature, the engagement feature in a first, retracted position.

FIG. 26 is a perspective view of the adjustable item engagement feature of FIG. 25 in a second, extended position.

FIG. 27 is a partial perspective view of a cart having a two-piece adjustable support shelf, the shelf in a back position and in an open position, with the cart supporting two buckets.

FIG. 28 is a perspective view of the two-piece shelf of FIG. 27, the shelf in a closed or operational position, and with the shelf in a forward position.

FIG. 29 is a perspective view of the two-piece shelf of FIG. 28, the shelf in an intermediate position and in the forward position.

FIG. 30 is a side elevational view of the shelf of FIG. 29 in the intermediate and forward positions.

FIG. 31 is a perspective view of another embodiment of a two-piece support shelf, the shelf in a closed or operational position.

FIG. 32 is a perspective view of the shelf of FIG. 31 in an open position.

FIG. 33 is a perspective view of another embodiment of a cart including a box or bucket carton retention bar.

FIG. 34 is a side view of the cart of FIG. 33 supporting three buckets.

FIG. 35 is a side view of the cart of FIG. 33 cart supporting four boxes.

FIGS. 36A through 36C are partial side views of the cart of FIG. 33 with the retention bar shown in a first position (FIG. 36A), in a second position (FIG. 36B) and in a third position (FIG. 36C).

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure and/or as defined by the appended claims.

### DETAILED DESCRIPTION

The present disclosure provides carts, dollies or hand trucks for lifting, transporting and lowering a container, such as a bucket. The carts of this disclosure are particularly suited for lifting, moving, and lowering 5-gallon buckets.

It should be understood that although the description herein refers to the device as a “cart”, the device may alternately be referred to as a “dolly”, “hand truck”, “hand cart”, “handcart”, “mover”, “2-wheeler”, “pallet truck”, etc. It should further be understood that although the description herein refers to the item moved by the cart as a “bucket” or “5-gallon bucket”, the cart can be configured to lift, transport and lower other items.

In the following description, reference is made to the accompanying drawing that forms a part hereof and in which is shown by way of illustration at least one specific embodiment. The following description provides additional specific embodiments. It is to be understood that still other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through the discussion provided below.

Unless otherwise indicated, all numbers expressing feature sizes, amounts, and physical properties are to be understood as being modified by the term “about.” Accordingly, unless indicated to the contrary, any numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “top”, “bottom”, “lower”, “upper”, “beneath”, “below”, “above”, “on top”, etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as ‘below’ or ‘beneath’ other elements would then be ‘above’ those other elements.

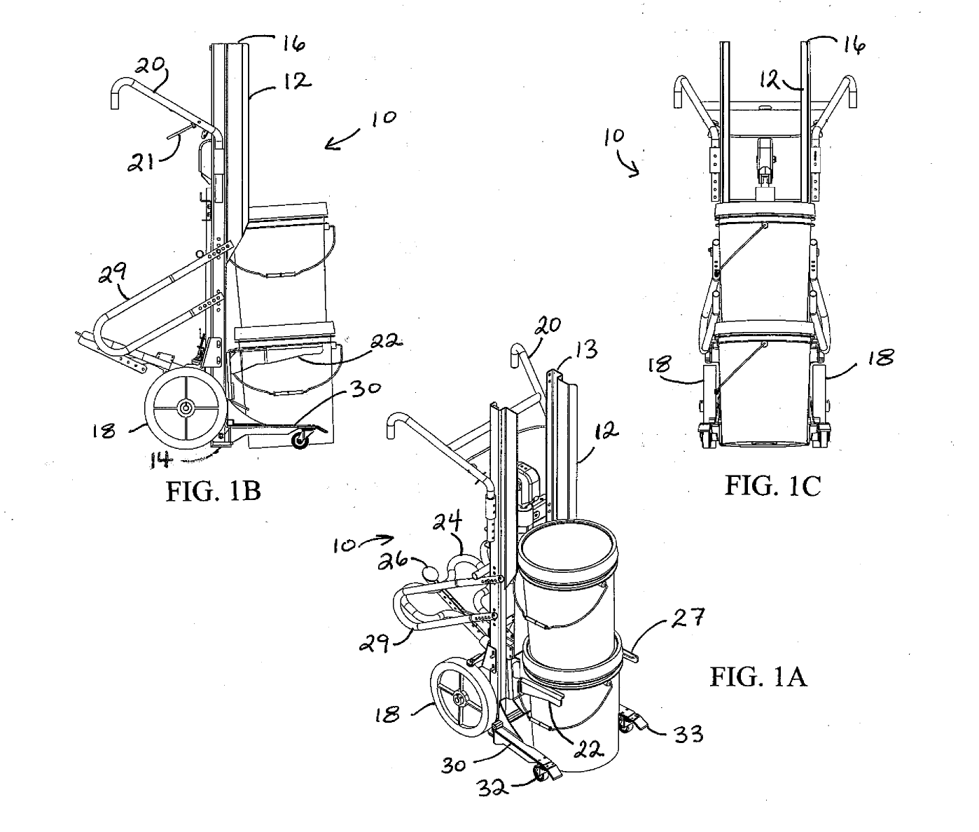

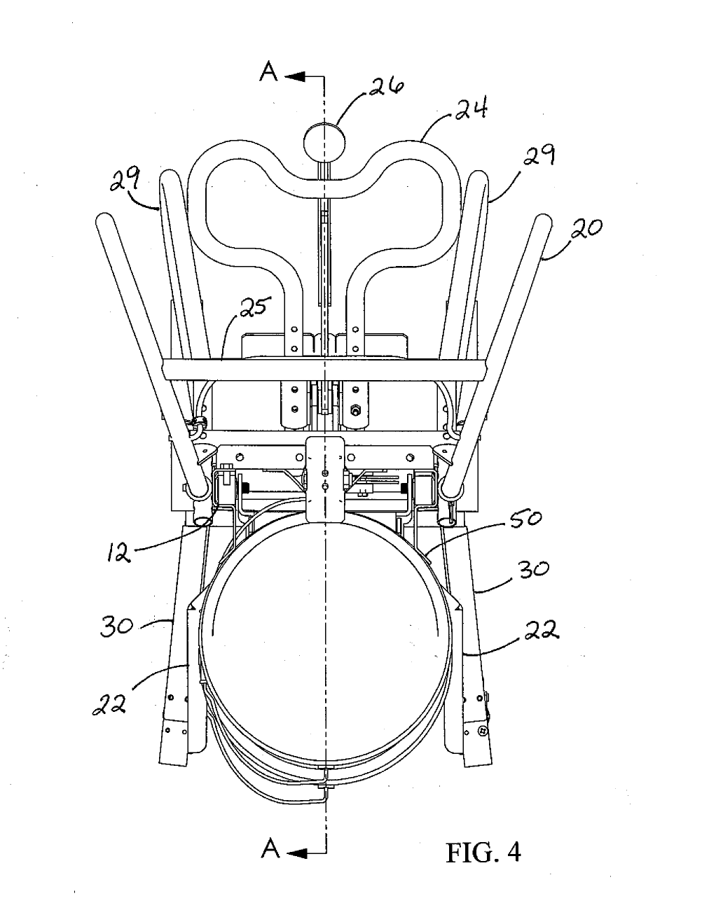

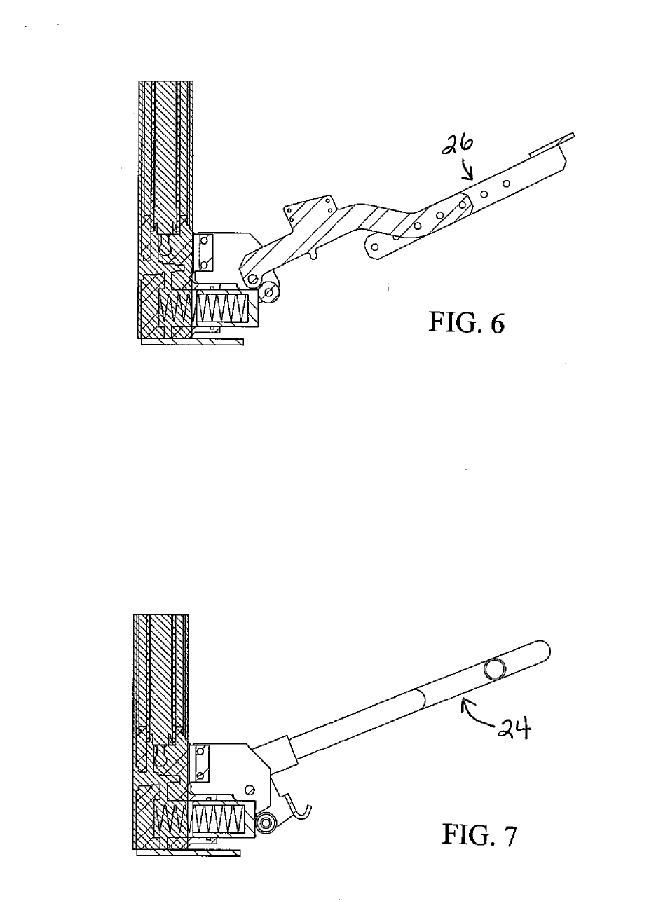

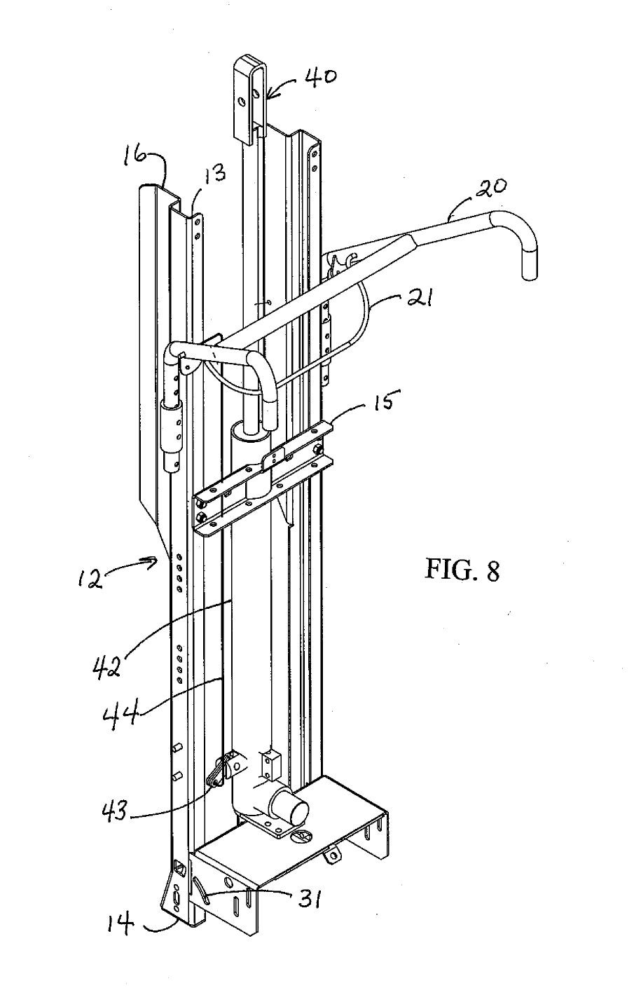

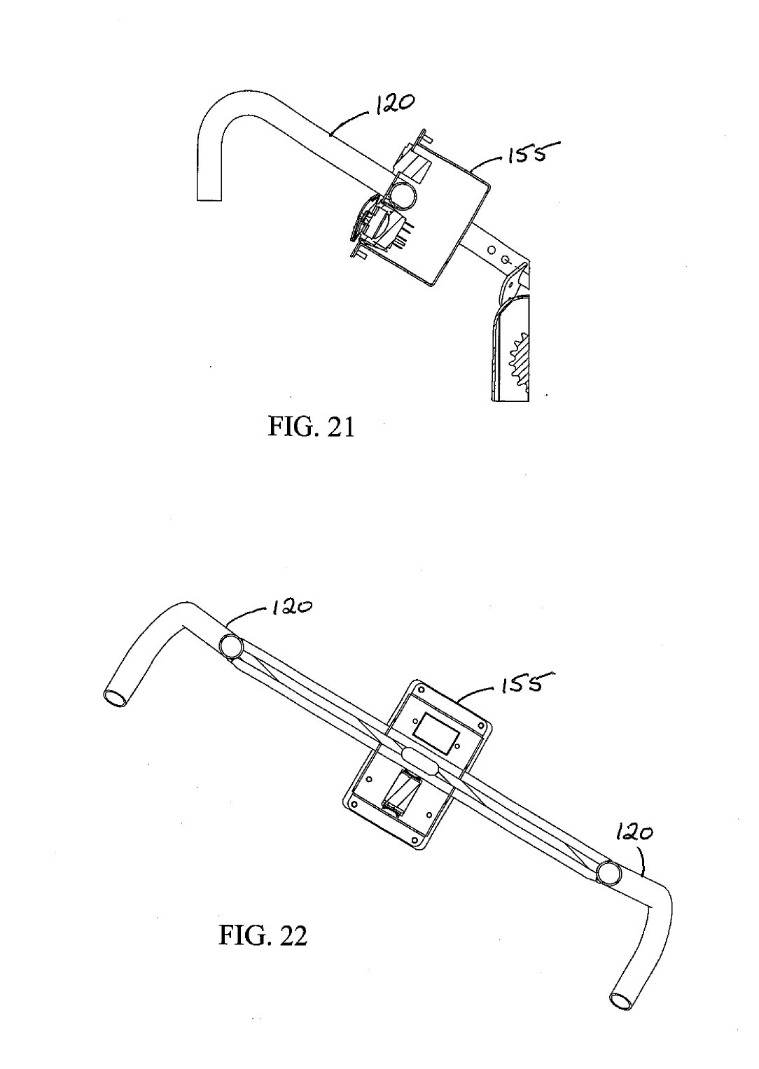

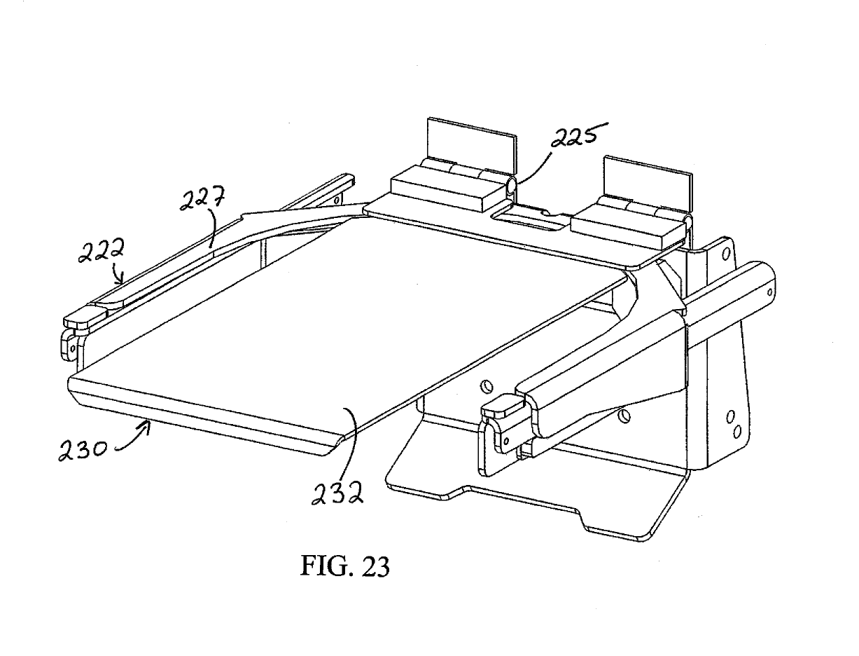

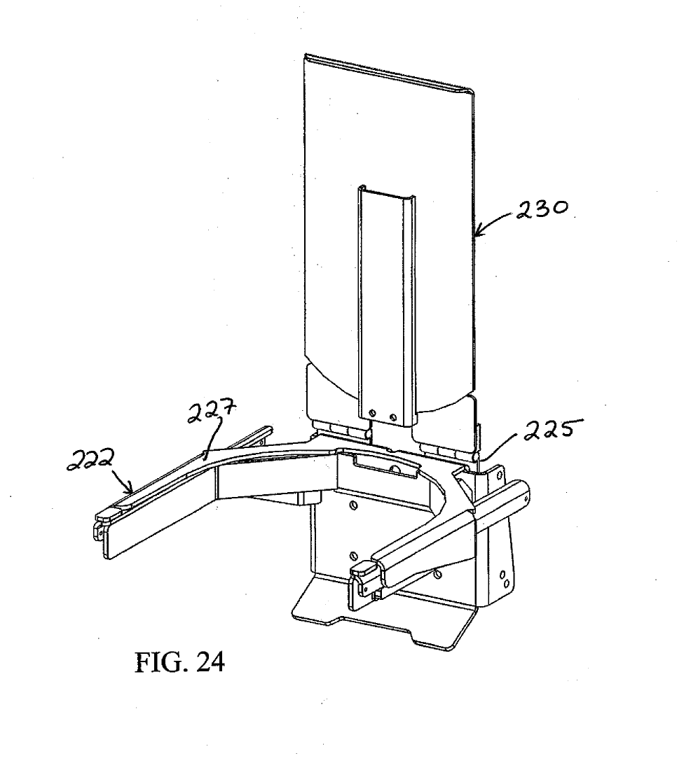

Referring now to the figures, various carts and features according to the present disclosure are illustrated in FIGS. 1 through 32. In some of these figures, a cart is illustrated retaining one or more buckets, such as a 5-gallon bucket; it should be understood that any of the carts illustrated or described herein can be modified to lift, hold, transport and lower other items, whether cylindrical or not.

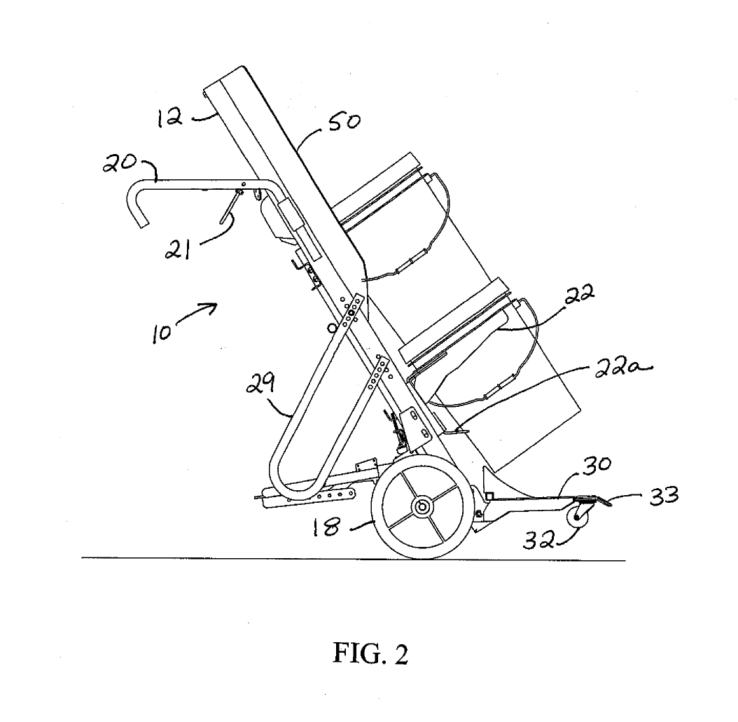

Referring to FIGS. 1A through 18, but particularly to FIGS. 1A, 1B, 1C and 2, a cart 10 is shown. Cart 10 has a structural frame 12 sufficiently strong and rigid to withstand tilting and moving of cart 10 while cart 10 is supporting and/or lifting an item. Examples of suitable materials for frame 12 include steel, iron, aluminum and other metals, reinforced plastics and polymeric composite materials. In this embodiment, frame 12 has a generally rectangular configuration, having a first end 14 at the bottom of cart 10 when cart 10 is in use, an opposite second end 16 at the top of cart 10 when cart 10 is in use, defined by various members extending vertically and horizontally, and with various braces and brackets, e.g., cross-member 15. In the illustrated embodiment, frame 12 is formed having a channel 13 (FIG. 1A). Other configurations of frame 12 may alternately be used.

At first end 14, cart 10 includes two primary wheels 18 that support cart 10 when cart 10 is ‘parked’ and which roll forward and back when cart 10 is in motion. To increase stability, particularly when parked, cart 10 includes a pair of front support arms 30 that support the cart, with or without a load, when the cart is in an upright position. Optionally, each front support arm may comprise at least one secondary wheel, such as a caster 32. Casters 32 on front support arms 30, together with wheels 18, allow cart 10 to stand up-right, whether loaded or not, without assistance; in other words, with front support arms 30 and casters 32, cart 10 is sufficiently stable to not require additional stabilization or support. It is noted that in the upright position, with wheels 18 and casters 32 resting on the floor, cart 10 can be moved (rolled) if any item supported by cart 10 is sufficiently lifted to not be in contact with the supporting surface (e.g., the ground).

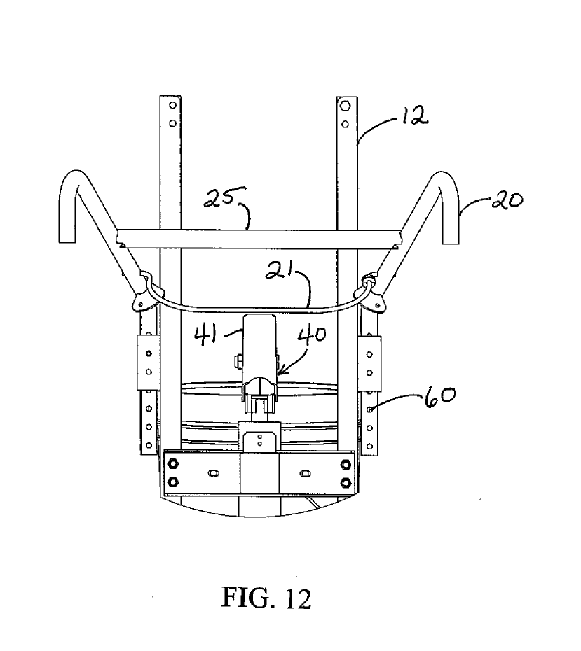

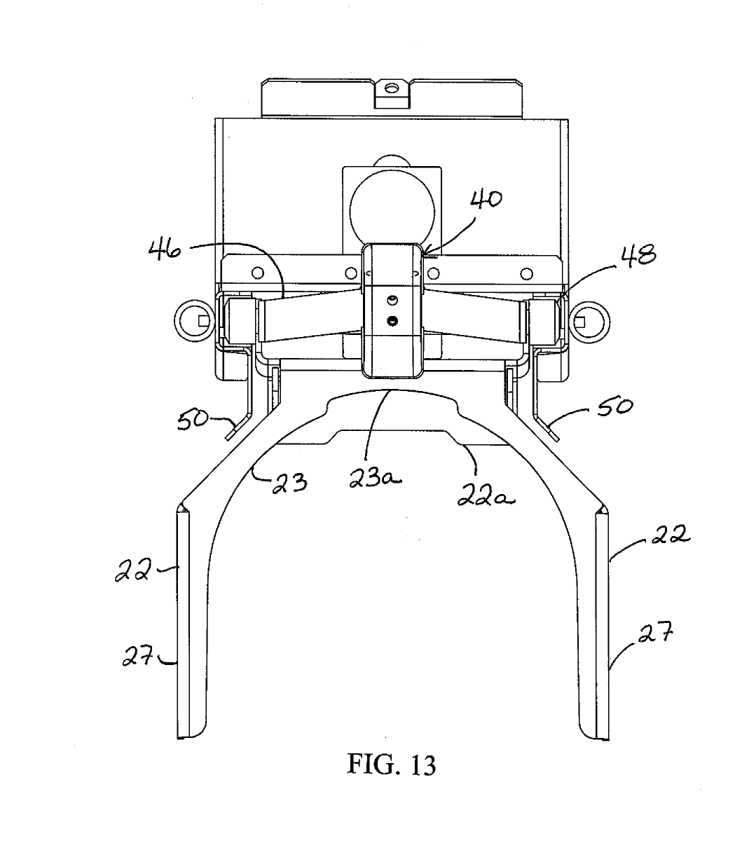

In FIGS. 1A, 1B and 1C, cart 10 is positioned at rest on a surface such as a floor, in a generally vertical position, supported by wheels 18 and casters 32. At or proximate to second end 16, cart 10 includes a handle 20 with a cross brace 25 (seen in FIG. 12) to facilitate controlled tipping and moving of cart 10 by a user. The height of handle 20 is adjustable in the illustrated embodiment, as best seen in FIGS. 11 and 12 which illustrate apertures 60 in handle 20 configured to receive a removable and movable quick-release locking pin 62. Other locking mechanisms and/or adjustable designs could certainly be used. In other embodiments, the handle may have a fixed height.

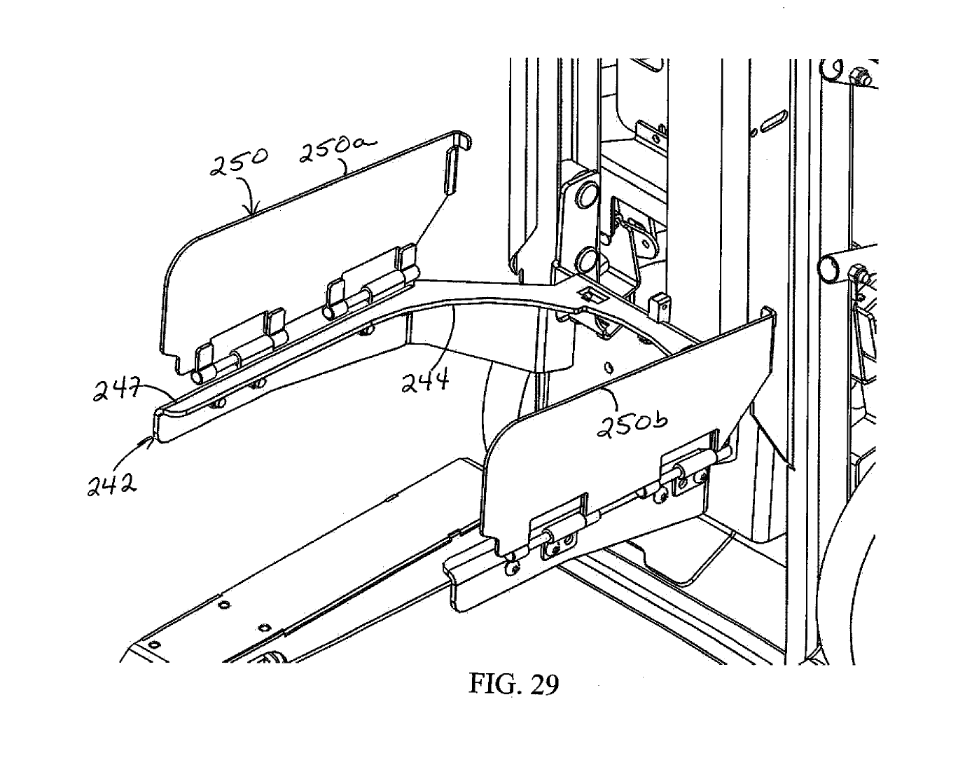

Cart 10 includes an engagement feature 22 configured to engage sidewalls or an element present on the sidewalls of an item (e.g., a 5-gallon bucket) and support the item. In the illustrated embodiment, engagement feature 22 is configured to receive and support a bucket with two upper opposite arms that do not fully encircle the bucket, but engage the bucket only so much as to sufficiently support and secure the bucket when the bucket is raised and when cart 10 is tipped for moving. Engagement feature 22 allows the bucket to be slid into and out from engagement feature 22, without the need to open clasps, straps, buckets, or the like when cart 10 is not tipped. Engagement feature 22 further includes a lower support member 22a (as seen, for example, in FIG. 2) that provides support and stabilization for the bucket when being loaded onto, or unloaded from, the cart. In other embodiments, a removable or replaceable strap or other mechanism may used to better secure the bucket to cart 10. See, for example, FIG. 27 (described further below), which includes a removable strap 300 to secure a bucket to a cart. Cart 10 includes a stabilization structure 50, best seen in FIGS. 2, 4 and 13, fixed to and extending along at least a portion of frame 12 parallel with frame 12. Stabilization structure 50 inhibits lateral or transverse movement of the bucket(s) held by engagement feature 22, particularly when cart 10 is tipped back toward the cart user. This embodiment of stabilization structured 50 is a wing-like structure, having two wings or wedges angling in toward a center axis of frame 12, although other variations can be used.

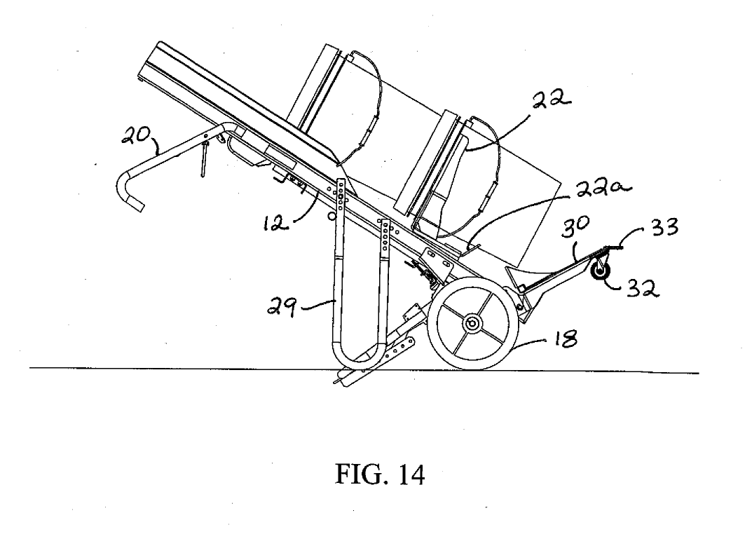

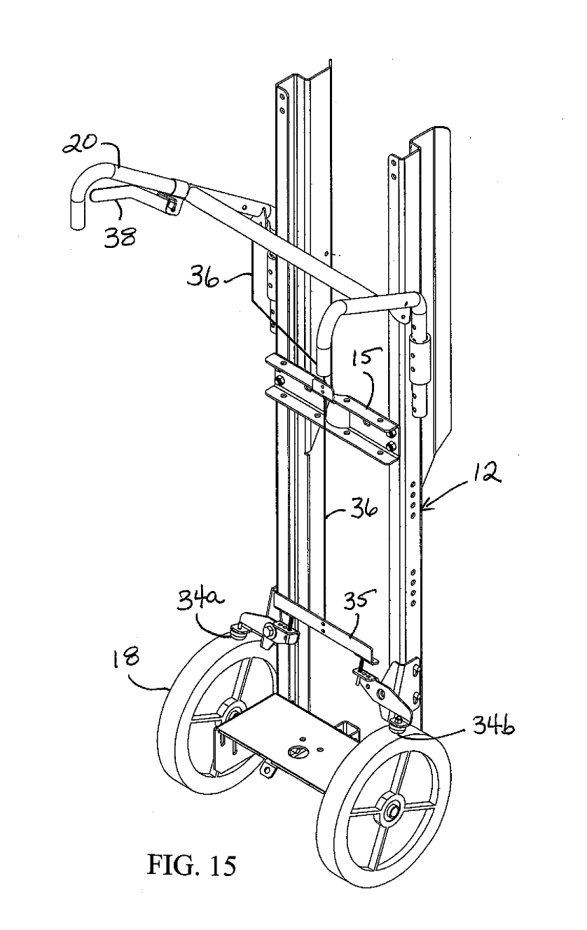

FIG. 13 illustrates engagement feature 22 having an arcuate inner surface 23 to better engage with the sidewall of a cylindrical item, such as a bucket, and also illustrates lower support member 22a. Inner surface 23 includes a clearance or recessed segment 23a that provides added bail clearance when loading or unloading buckets or containers from the cart. Clearance segment 23a allows buckets or containers to rest further against the engaging portions of engagement feature 22 when the bail of the bucket, for example, is positioned or turned 90 degrees as seen in FIG. 14. Lower support member 22a supports the bucker or container while transferring a load to or from the cart because it provides a rest for the lower portion of the bucket or container and further stabilizes and positions the bucker or container during release and transfer. In use, when retaining a bucket, engagement feature 22 seats below a circumferential outwardly extending flange commonly found on 5-gallon buckets, as seen in FIG. 1A. As engagement feature 22 is raised, an upper ledge 27 (seen in FIG. 1A and FIG. 13) of engagement feature 22 engages and lifts the bucket due to contact on the bottom of the flange.

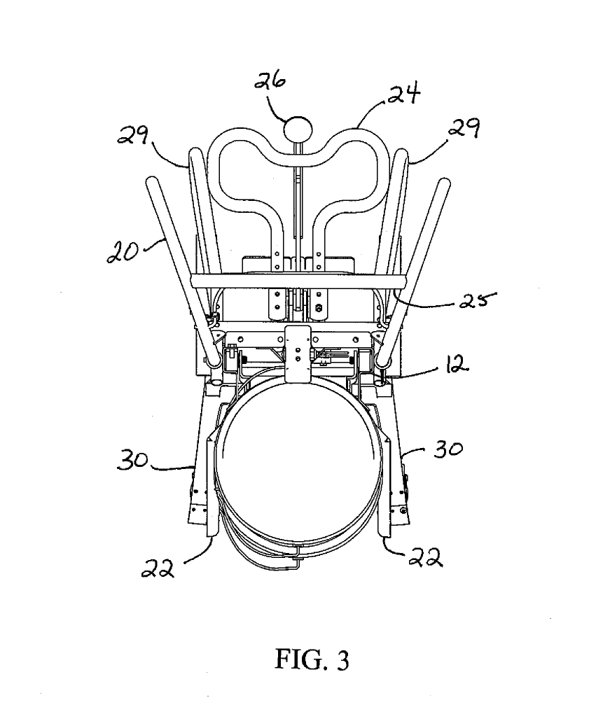

FIG. 1A and FIG. 2 illustrate engagement feature 22 moveably mounted to frame 12, moveable between first bottom end 14 and second top end 16. Cart 10 includes an item elevation adjustment system that moves (i.e., raises and lowers) items that are engaged by engagement feature 22. The elevation adjustment system includes various elements configured to move engagement feature 22 along frame 12, so that a bucket or other item can be lifted, held in a lifted position, and lowered, as desired. FIGS. 3 through 13 and 17A, 17B illustrate various additional features of the elevation adjustment system.

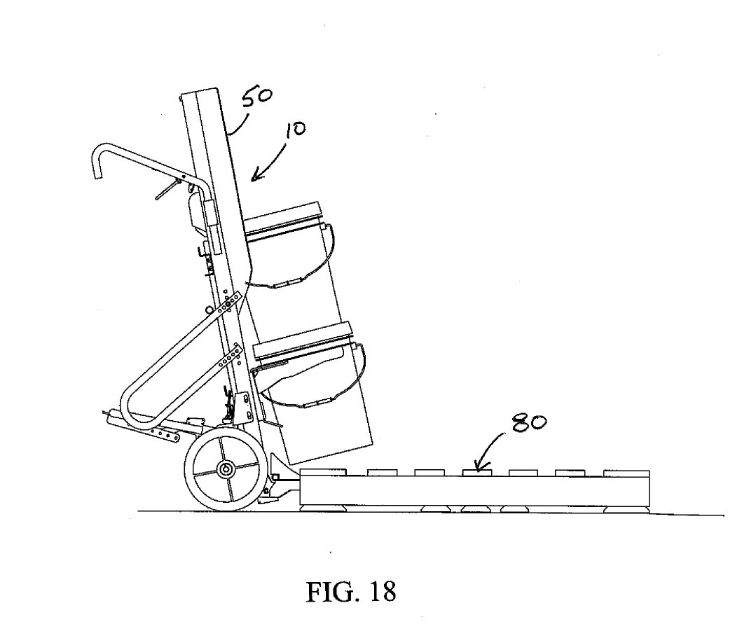

In FIGS. 17A and 17B, engagement feature 22 is shown moveably engaged with frame 12. In particular, engagement feature 22 includes rollers 28 configured to move within channel 13 of frame 12, thus allowing controlled movement of engagement feature 22 between bottom end 14 and top end 16.

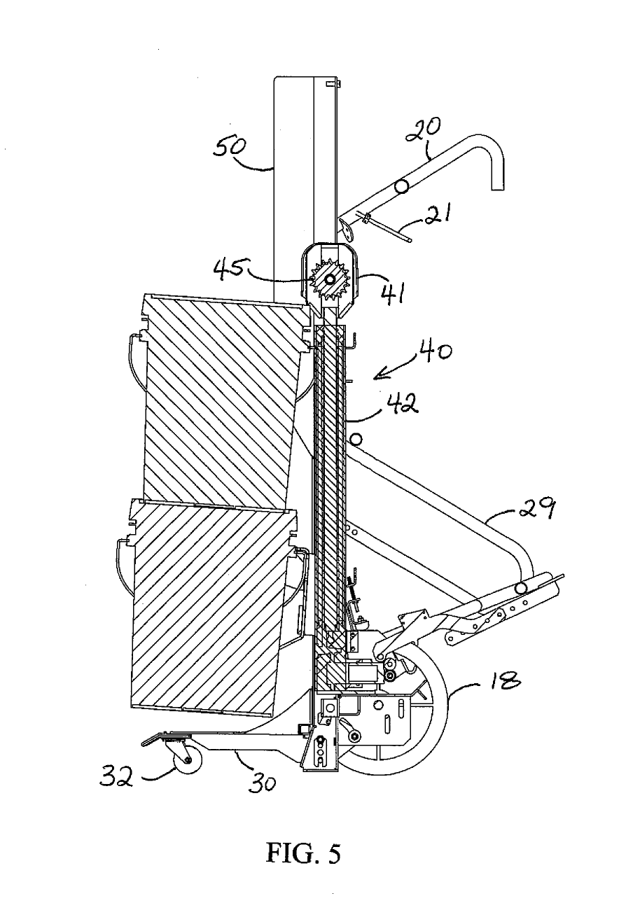

Turning to FIGS. 3 through 7, as part of the elevation adjustment system, cart 10 includes a first or fast elevation adjustment lever 24 and a second or slow elevation adjustment lever 26. Each of fast elevation adjustment lever 24 and slow elevation adjustment lever 26 is foot-activated, positioned and configured to readily receive a user's foot thereon, to activate an elevation adjustment mechanism 40 (FIG. 5) to raise the item held by cart 10. Both foot levers 24, 26, are operably connected to a lifting mechanism 42, in this embodiment a hydraulic cylinder, that is in turn connected to a sprocket 45 (seen in FIG. 5) and protected by cover 41, which is operably connected to engagement feature 22.

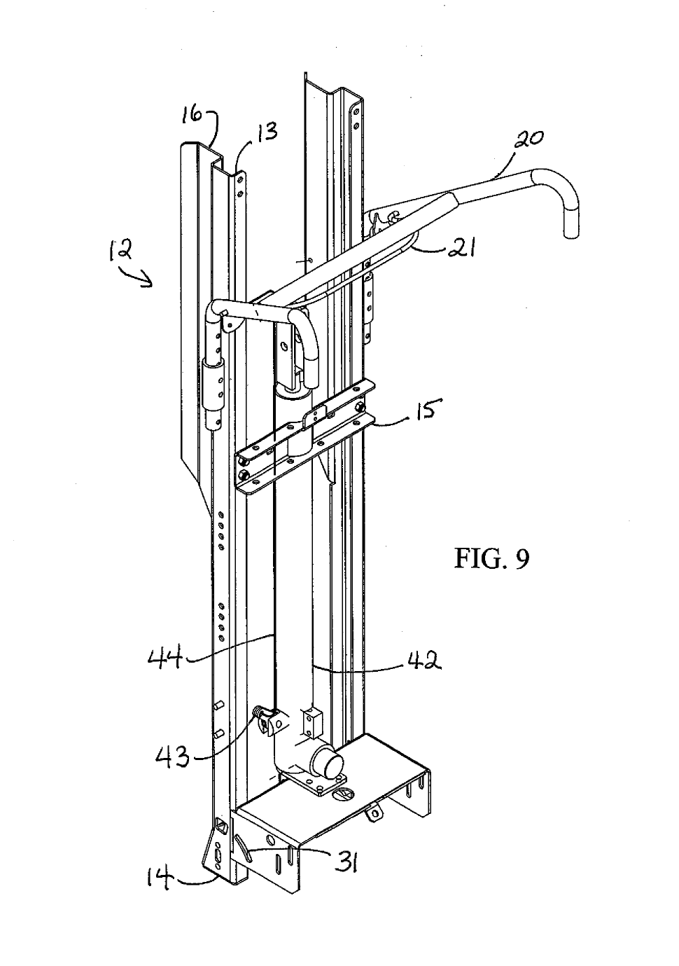

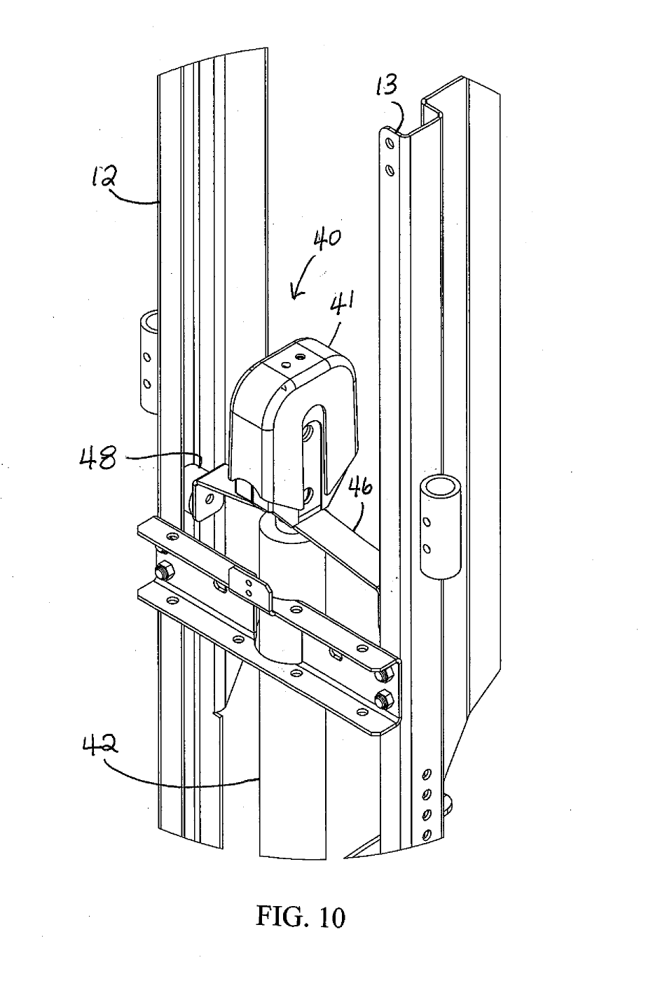

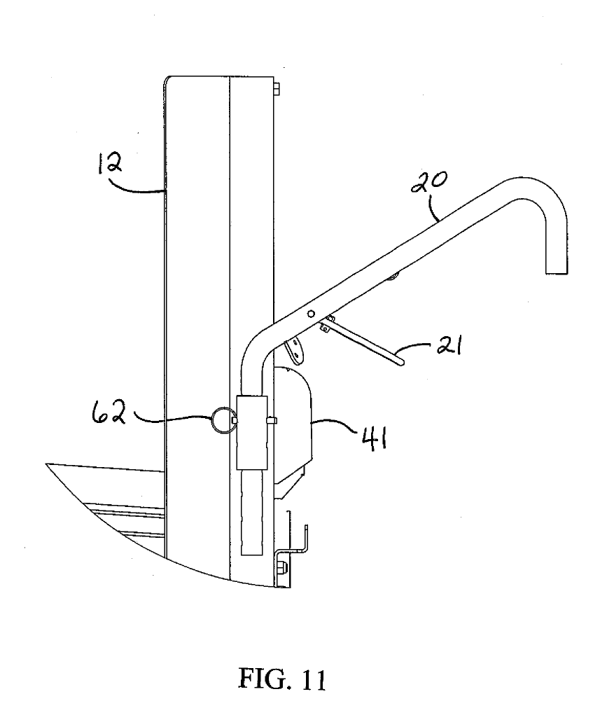

Activation of hydraulic cylinder 42 via either foot lever 24, 26 results in movement of sprocket 45 in relation to frame 12 and thus the movement of engagement feature 22 in relation to frame 12. Hydraulic cylinder 42 is configured to move sprocket 45 between bottom end 14 and top end 16. Sprocket 45 may be reinforced by any suitable structure to inhibit twisting. As seen in FIGS. 10 and 13, cart 10 includes two reinforcing arms 46 extending from hydraulic cylinder 42 and/or sprocket 45 to rollers 48, which are moveably engaged in channel 13 of frame 12. Seen in FIGS. 8 and 9, a cable 44 connects release lever 21 to cylinder 42, particularly to switch 43 (e.g., a pressure release valve) on cylinder 42, which changes the direction of movement of engagement feature 22. In some embodiments, foot levers 24, 26 move engagement feature 22 up frame 12, toward top end 16, and activation of release lever 21 automatically lowers engagement feature 22 toward bottom end 14. In other embodiments, activation of release lever 21 changes the direction of travel of engagement feature 22, so that activation of foot levers 24, 26 controllably moves engagement feature 22 toward bottom end 14. The various figures illustrate an embodiment of activation foot levers 24, 26, hydraulic cylinder 42, release lever 21, etc.; of course, lifting mechanisms such as hydraulic cylinders, their configurations and uses are well known, and other variations can be used.

FIGS. 5 through 7 illustrate fast elevation adjustment foot lever 24, configured to produce a larger distance of travel of sprocket 45 than slow elevation foot lever 26, which is configured to produce a shorter distance of travel, but which is configured to easier manage heavier items being held. That is, fast elevation adjustment lever 24 is preferred for lighter, low weight items, and a higher force is needed on lever 24 to move the item, whereas slow elevation adjustment lever 26 is preferred for heavier, high weight items, and a lower force is need on lever 26 to move the item. In sum, lever 24 requires more foot force by the user's foot but provides fast movement of light loads, whereas lever 26 provides an easier activation by the user's foot for heavier loads, but provides slower movement.

Returning to FIGS. 1A, 1B and 2, cart 10 includes, rigidly fixed to frame 12, a rear stop bar 29 to inhibit tipping or titling cart 10 too far back toward the user during transport of cart 10. In some embodiments, stop bar 29 may be used to completely support a tipped cart 10, allowing the user to release hold of the cart; see FIG. 14. Rear stop bar 29, in the illustrated embodiments, allows cart 10 to tip no more than 75 degrees from vertical, in some embodiments no more than 45 degrees from vertical.

Cart 10 also includes front support feature 30, which in this embodiment is a pair of support arms 30. Arms 30 support secondary wheels such as casters 32 and also provide increased stability and support to cart 10.

The angle of front support arms 30 in respect to frame 12 may be fixed or may be adjustable. Any adjustment, accomplished either manually or automatically, can be based on the angle or amount of tip of cart 10. See for example, FIG. 1B, where cart 10 is positioned so that frame 12 is at an angle of about 90 degrees to the ground and support arms 30 form a 90 degree angle with frame 12. In FIG. 2, cart 10 is tipped so that frame 12 is at an angle of about 60 degrees to the ground and support arms 30 form an angle of about 120 degrees with frame 12. In FIG. 14, cart 10 is tipped so that frame 12 is at an angle of about 30 degrees to the ground and support arms 30 form an angle of about 120 degrees with frame 12. In some embodiments, support arms 30 may be configured with only several set relative positions between frame 12 and support arms 30, whereas in other embodiments, support arms 30 may have a range of angles relative to frame 12.

In FIGS. 8 and 9, a slot 31 is shown in a bracket to which support arms 30 connect. Support arms 30 may be pivotally connected to the bracket and thus frame 12, and thus provided with a range of possible angles between frame 12 and support arms 30, e.g., between 90 and 120 degrees. The pivotal connection may be sufficiently loose that the angle adjusts automatically with tipping of cart 10, particularly when sliding arms 30 into or under a pallet.

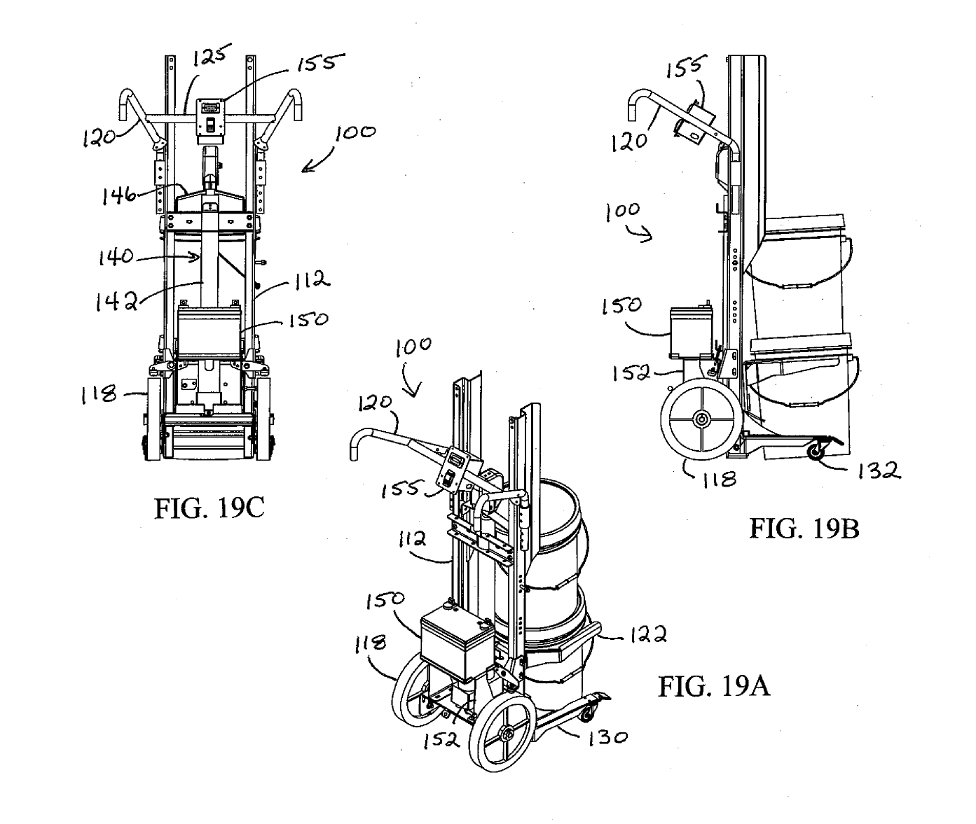

Support arms 30 include inclined distal ends 33 (see, e.g., FIGS. 1A, 2, and 14) which facilitate positioning cart 10 when picking up or depositing items on to elevated surfaces. As seen in FIG. 18, supports arms 30 with inclined distal ends 33 can readily be slid into or under a pallet 80 under the item-retaining surface; this allows engagement feature 22 to be closer to the item and improve the stability of the item when lifted off from pallet 80 or when deposited on to pallet 80.

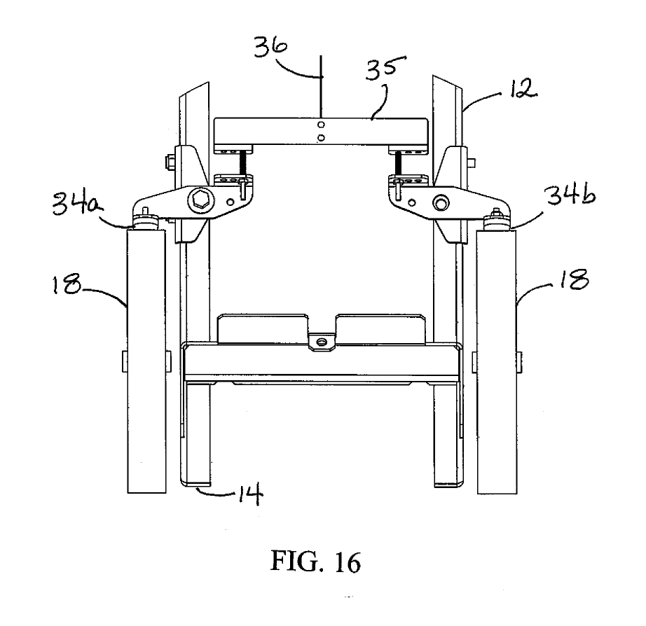

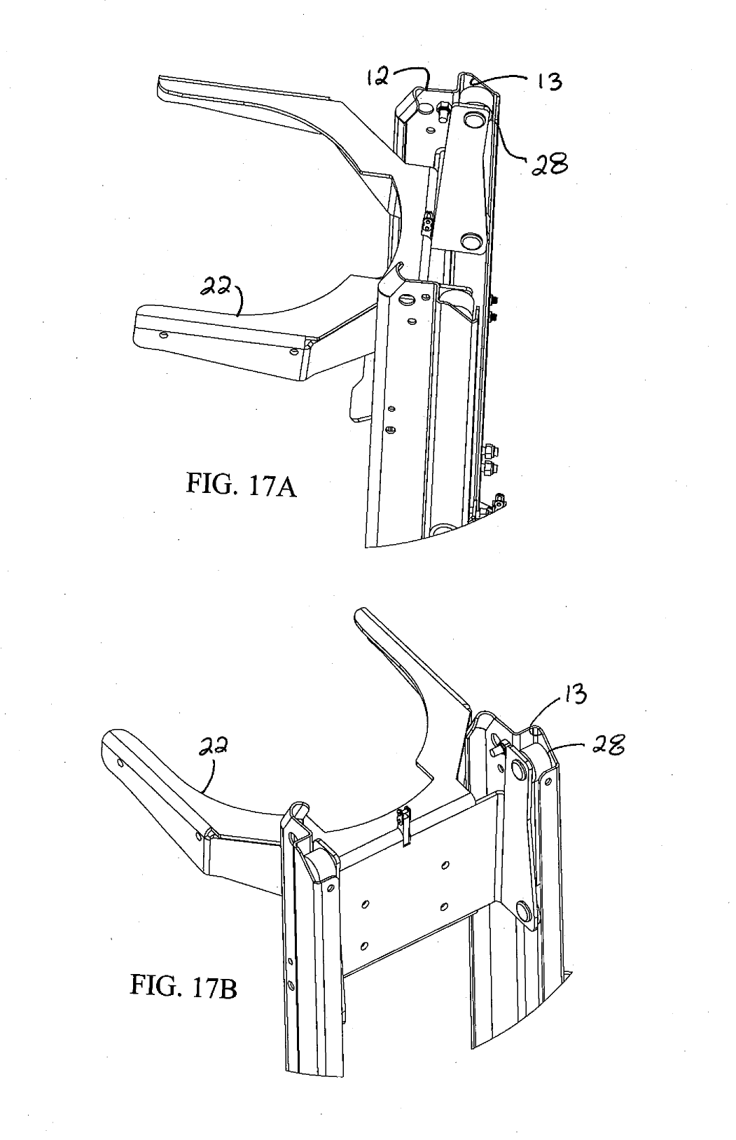

To further improve control of cart 10 during the transport of items, cart 10 can include a braking system; FIGS. 15 and 16 illustrate an embodiment of a suitable braking system. Moveable into contact with and away from wheels 18 are friction brake pads 34a, 34b (one for each wheel 18), which, when in contact with wheels 18, create friction therebetween to slow the turning wheels 18. Brake pads 34a, 34b are connected and work in unison via connector bar 35, which is activated by brake lever 38 in turn connected to connector 35 by cable 36. As lever 38 is depressed, cable 36 pulls upward on connector bar 35, which pivots pads 34a, 34b to contact wheels 18. Through connector bar 35 and cable 36, the force on pads 34a, 34b is balanced, so that engagement of brake lever 38 provides substantially equal pressure from each pad 34a, 34b onto their respective wheel 18. Brake lever 38 may include a locking mechanism, such as a button, to retain brake lever 38 and thus pads 34a, 34b in an engaged position.

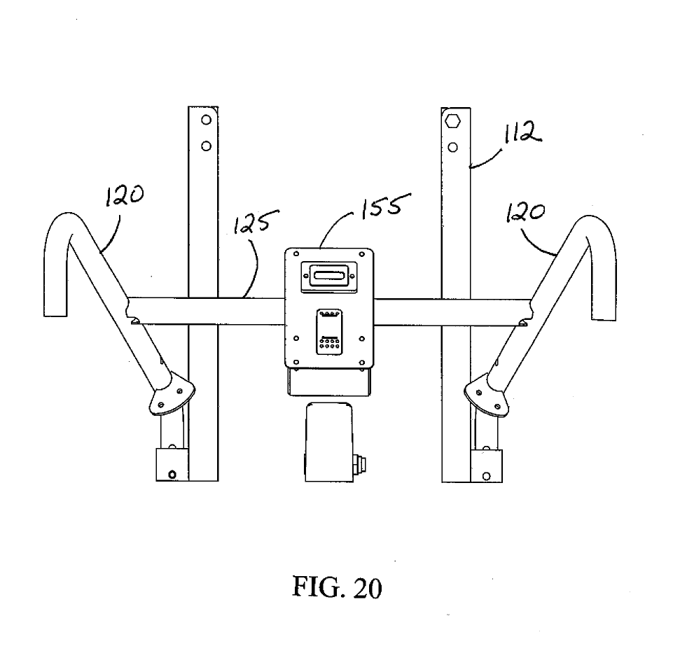

FIGS. 19A, 19B, 19C through 22 are directed to another embodiment of a cart, similar to cart 10 in many aspects. The cart of FIGS. 19A, 19B, 19C through 22 includes an electrically (e.g., D/C) powered lifting mechanism. Unless indicated, features from cart 10 are applicable to cart 100.

Cart 100 has a structural frame 112 with a generally rectangular configuration, having a first end at the bottom of cart 100 when cart 10 is in use, an opposite second end at the top of cart 100 when cart 100 is in use, defined by various members, braces and brackets extending vertically and horizontally. Other configurations of frame 112 may alternately be used. Cart 100 includes two primary wheels 118 and a pair of front support arms 130 that support the cart, with or without a load, in an upright position. Optionally, each front support arm may comprise at least one secondary wheel or caster 132. A handle 120 with a cross brace 125 is present to facilitate tipping and moving of cart 100 by a user. Cart 100 includes an item engagement feature 122 movable along frame 112 by an elevation adjustment mechanism 140, in this embodiment, a powered lifting mechanism 142, such as a linear actuator. Cart 100 may also include any suitable structure to inhibit twisting of elevation adjustment mechanism 140 and any of the elements thereof; in FIG. 19C, two reinforcing arms 146 extending from the elevation adjustment mechanism to rollers (not shown) that are moveably engaged to frame 112.

Cart 100 includes a self-contained power source, such as a battery 150, supported on bracket 152 connected to frame 112. Battery 150 is operably connected to linear actuator 142 to move engagement feature 122 along frame 112. Battery 150 may be, for example, a rechargeable battery. The movement of engagement feature 122 is controlled by control module 155 positioned on cross brace 125 of handle 120, which can include a speed adjustment control and a reverse switch to change the direction of travel of linear actuator 142.

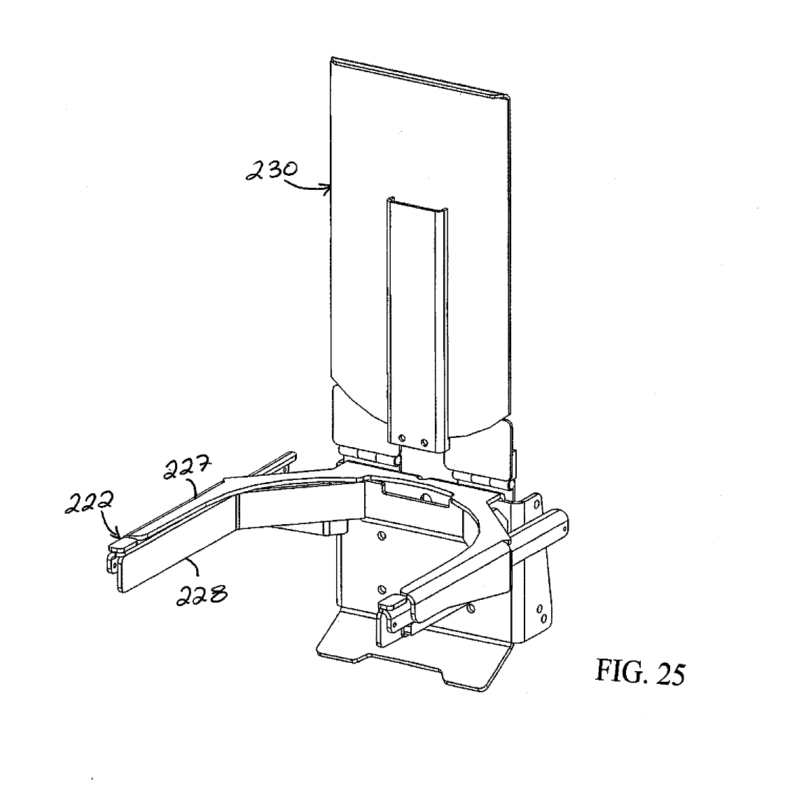

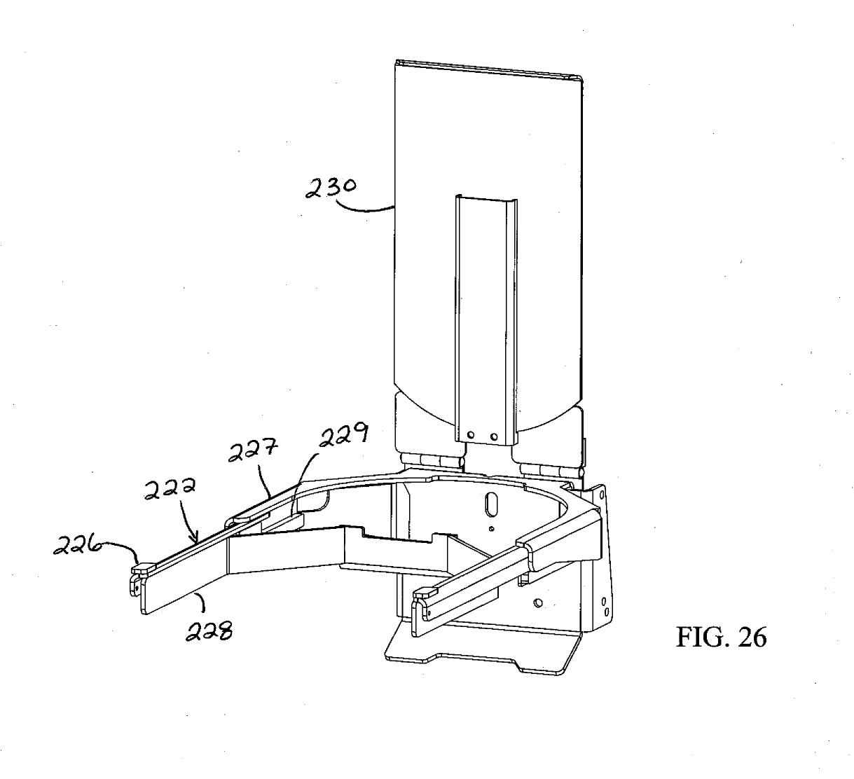

Either or both cart 10 or 100 could include a solid supporting element, in addition to engagement feature 22, 122. Referring to FIGS. 23 and 24, an engagement feature 222 is illustrated, configured to engage with sidewalls of an item, such as a bucket. Engagement feature 222 includes an upper ledge 227, configured to engage with an outwardly extending flange on the sidewalls of a 5-gallon bucket. Also illustrated is a supporting element 230 with a top surface 232, configured to support an item by its bottom surface. Examples of items that could be placed on top surface 232 include boxes (e.g., boxes having paint cans therein), cans, or buckets. Supporting element 230 is configured to move along the frame of the cart in the same fashion as engagement feature 222. Supporting element 230 can be integral with or fixed to engagement feature 222; in this embodiment, supporting element 230 is hingedly connected to engagement feature 222 via hinge 225. In FIG. 23, supporting element 230 is positioned to receive an item on surface 232. In some embodiments, when supporting element 230 is in this operational position, top surface 232 is co-planar with upper ledge 227, thus expanding the available surface area to support the item. When not in use, supporting element 230 can be pivoted or retracted, as in FIG. 24, to inhibit interference with engagement feature 222.

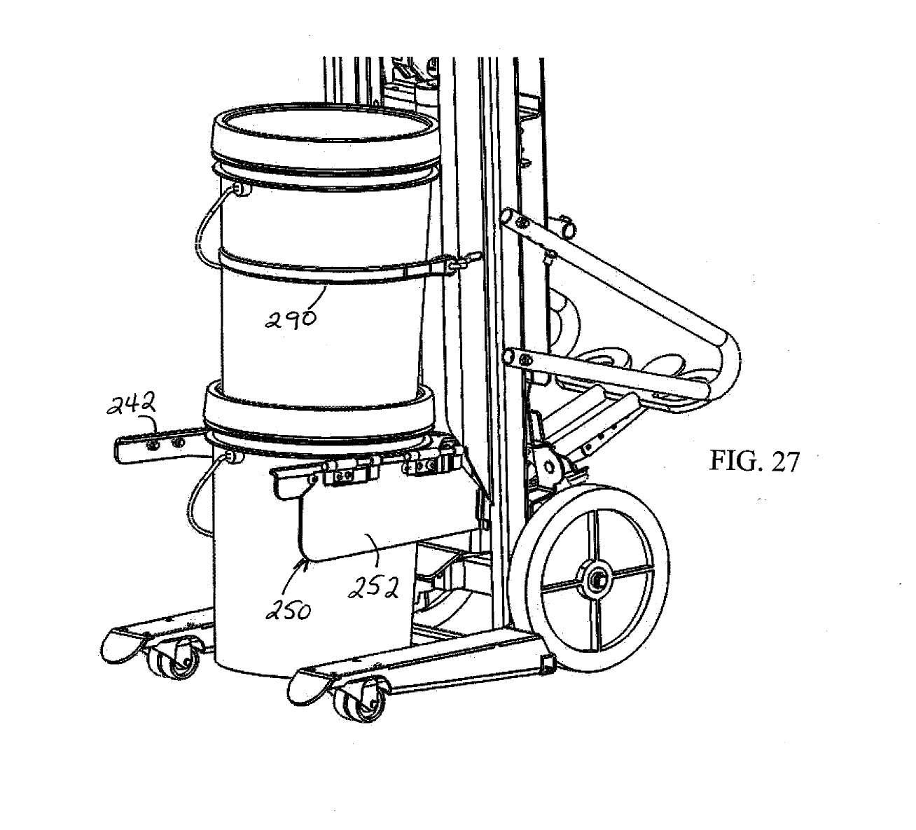

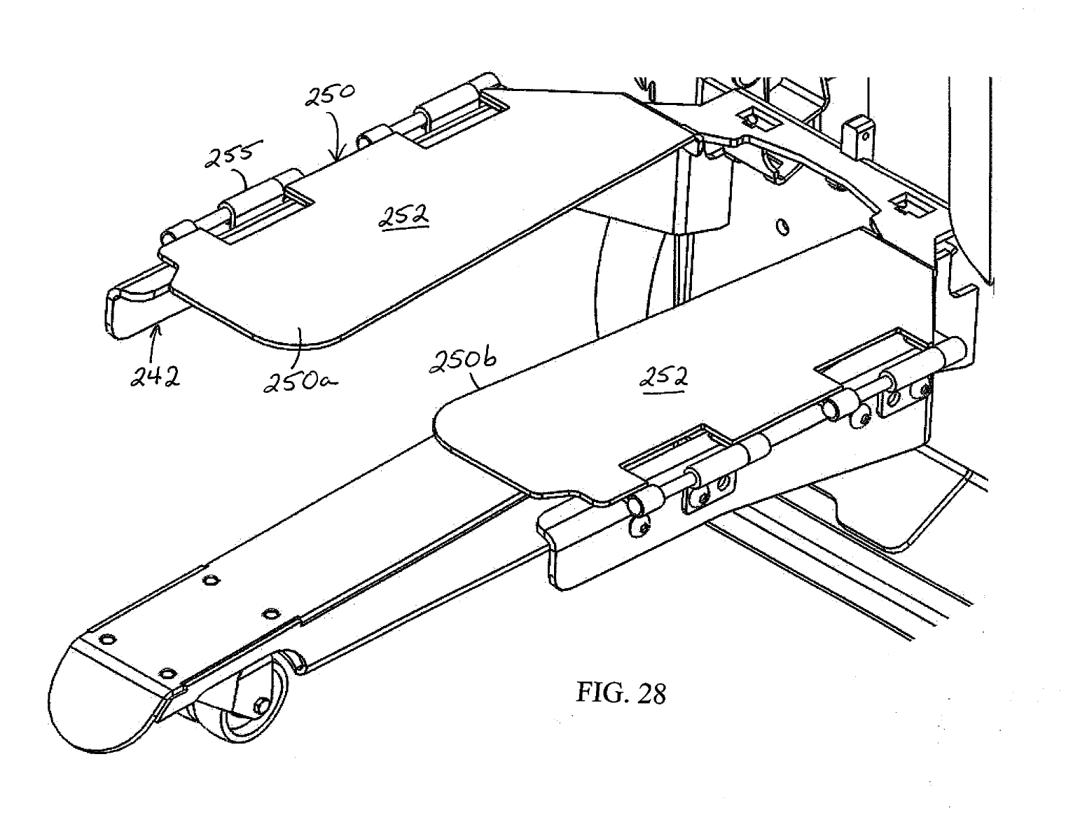

Additionally, all or a portion of the item engagement feature, either with or without having a solid supporting element, may be adjustable. Referring to FIGS. 25 and 26, engagement feature 222 is shown composed of a first extension member 228 and a second extension member 229. First extension member 228 is inwardly and outwardly adjustable in relation to second extension member 229 and to upper ledge 227 and also in relation to the frame of the cart. In FIG. 26, first extension member 228 is shown extended outward away from second extension member 229. First extension member 228 is configured to extend the reach of engagement feature 222, for example, to engage an item (e.g., bucket) that is positioned in from the edge of a pallet. First extension member 228 may include an upper ledge 226 to partially support an outwardly extending flange on the sidewalls of a 5-gallon bucket until first extension member 228 is retracted and the flange can engage with upper ledge 227.

As an example for a use of such a forward (outward) and backward (inward) adjustable engagement feature, when extended, first extension member 228 can reach and lift a 5-gallon bucket from the middle of a pallet. The forward casters (e.g., casters 32 on support 30) inhibit the cart from tipping forward. The bucket can be lifted off from the center of the pallet and set down on the edge of the pallet or on the ground, where the cart can be pushed toward the bucket, thus pushing in extension member 228. With extension member 228 pushed in and aligned with extension member 229, the bucket is fully supported by upper ledge 227 and can be moved.

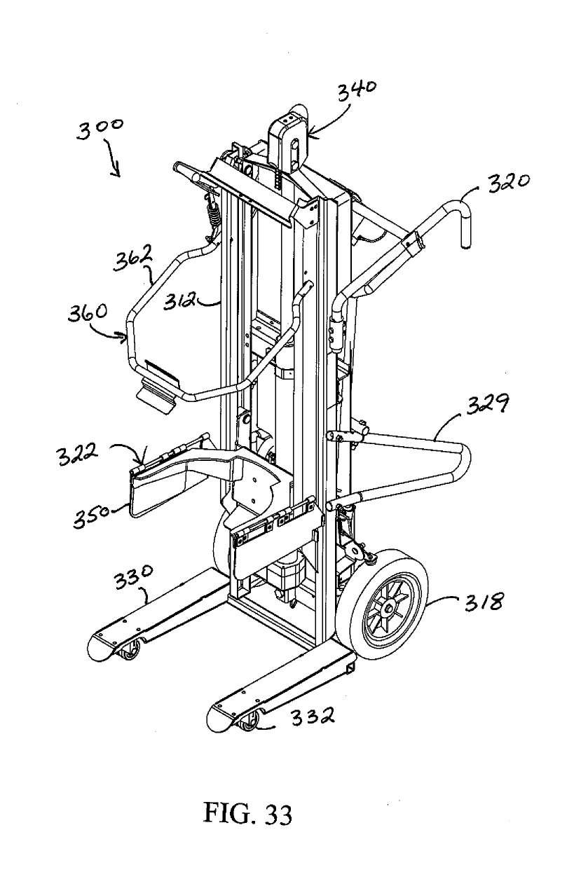

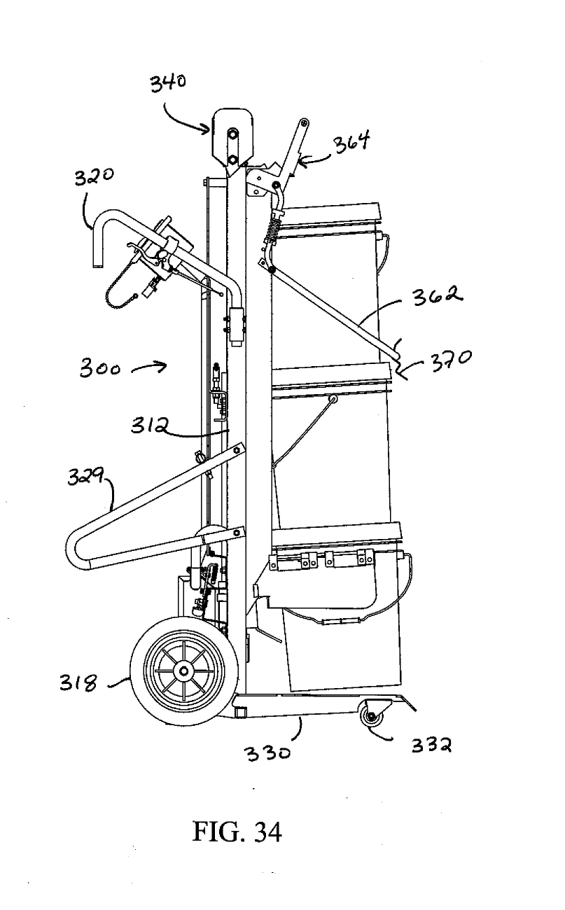

FIG. 27 through FIG. 32 show alternate supporting elements for a transport cart, the supporting elements being two-piece elements configured to hold an item by its bottom surface. FIGS. 27 through 30 illustrate an embodiment where the two-piece support element is laterally movable, toward and away from the frame of the cart, whereas FIGS. 31 and 32 illustrate an embodiment where the two-piece support element is laterally fixed in relation to the frame of the cart.

Referring to FIGS. 27 through 30, an engagement feature 242 having an inner surface 244, a portion of which is arcuate, is illustrated, configured to be in close contact with sidewalls of an item, such as a bucket. Engagement feature 242 includes an upper ledge 247, configured to engage with an outwardly extending flange on the sidewalls of a 5-gallon bucket. Also illustrated is a supporting feature 250 having a first support element 250a and a second support element 250b, each having a top surface 252. Either alone or together, support elements 250a, 250b are configured to support an item by its bottom surface on top surface 252. Examples of items that could be placed on top surface 252 include boxes, cans, and buckets.

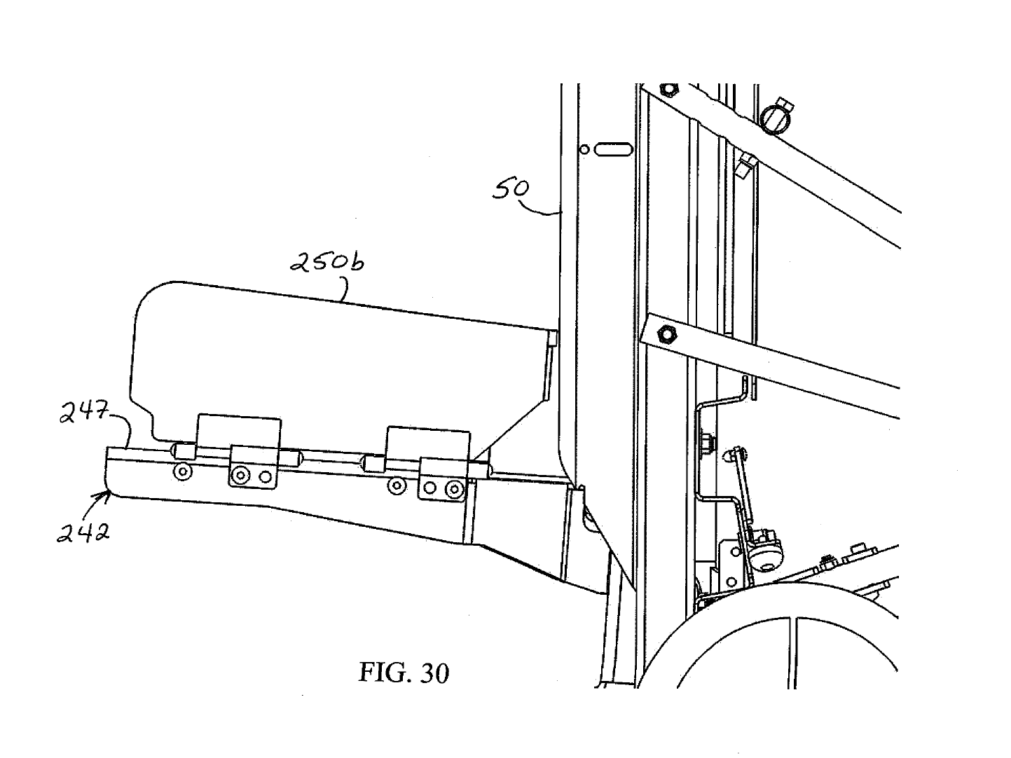

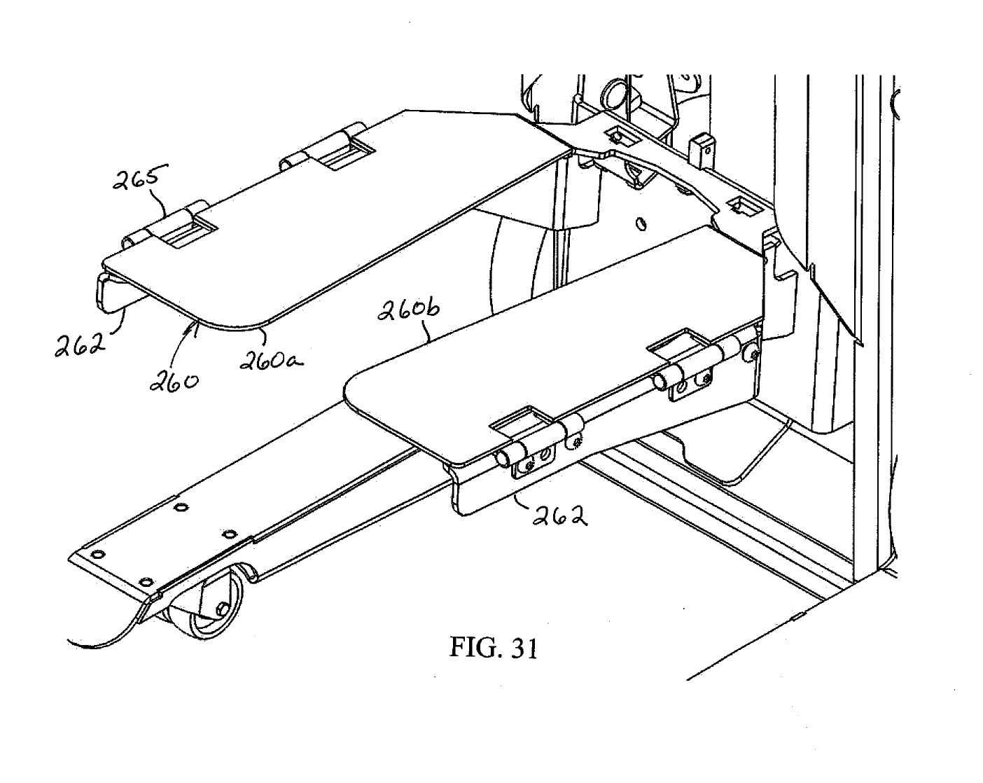

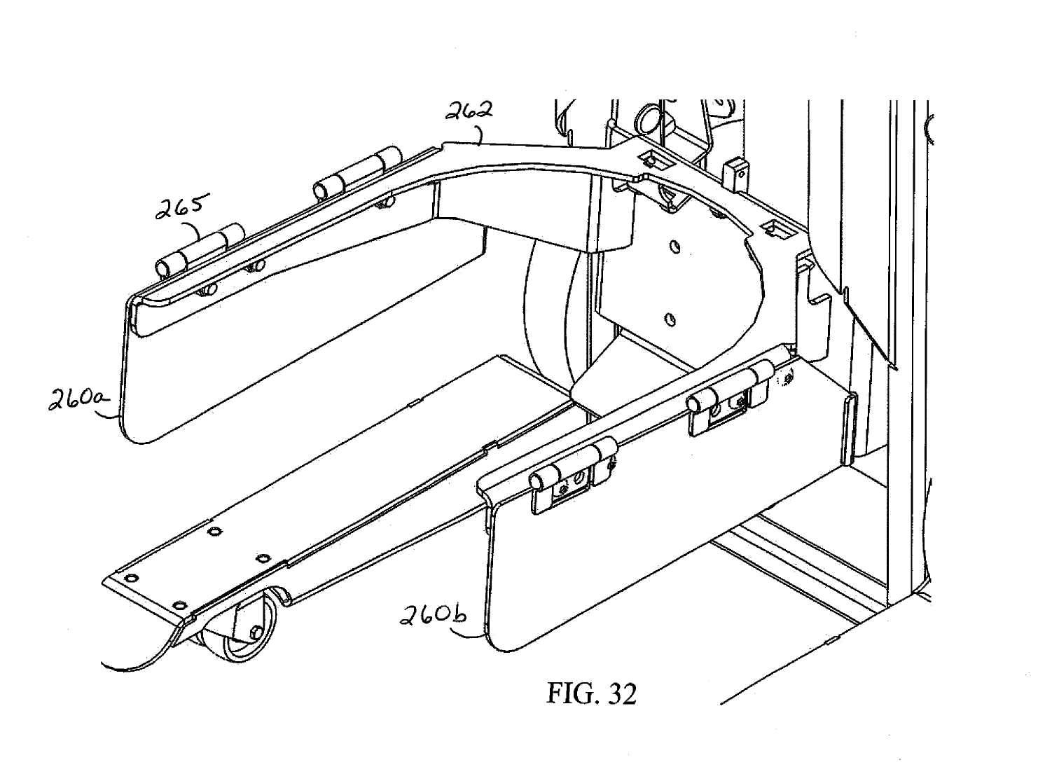

Supporting feature 250 is fixed to engagement feature 242 and configured to move along the frame of the cart in the same fashion as engagement feature 242. Supporting elements 250a, 250b are hingedly connected to engagement feature 242 by hinges 255 and are movable from an “open” position (FIG. 27) to a “closed” position (FIG. 28). When supporting elements 250a, 250b are in their “open” position, as in FIG. 27, and in the intermediate position, as in FIGS. 29 and 30, engagement feature 242 is available to engage buckets or other items. In the “closed” position, as in FIG. 28, top surface 252 is available to accept and support an item thereon. When closed, supporting feature 250 is not planar with but is positioned on or above engagement feature 242. Upper ledge surface 247 of engagement feature 242 may support and/or reinforce feature 250.

Supporting elements 250a, 250b and hinges 255 are configured to allow outwardly forward and inwardly back movement of supporting elements 250a, 250b in relation to engagement feature 242 and to the cart's frame. This movement facilitates centering of supporting elements 250a, 250b under the item being supported. Additionally, depending on the size of elements 250a, 250b and the configuration of the cart's frame and other elements, the ability of outward and inward movement allows constructions and configurations that might otherwise not be readily feasible. For example, in the embodiment of FIGS. 27 through 30, the cart includes wing-like stabilization structure 50 to inhibit lateral movement of items held by engagement feature 242. Depending on the distance structure 50 extends down toward engagement feature 242, and the size of elements 250a, 250b, the presence of stabilization structure 50 may block movement between the open and the closed position of elements 250a, 250b, due to structure 50 extending into the path of elements 250a, 250b. Moving elements 250a, 250b outwardly forward provides clearance around stabilization structure 50. See, for example, FIG. 30, which illustrates supporting element 250b clearing stabilization structure 50.

When elements 250a, 250b are open (as in FIG. 27) and in an intermediate position (as in FIGS. 29 and 30), they are able to freely moved inward and outward. For example, if elements 250a, 250b are extended outward and they hit something such as an adjacent bucket, box or other item, elements 250a, 250b will readily slide back, out of the way. When elements 250a, 250b are closed (as in FIG. 28), they may be locked or otherwise inhibited from inward and outward movement. In some embodiments, the closed position may only be achieved in an outward position, whereas in other embodiments the closed position may only be achieved in an inward position.

FIGS. 31 and 32 show an embodiment of a two-piece supporting feature 260 having a first support element 260a and a second support element 260b, each hingedly connected to an engagement feature 262 by hinges 265. Similar to the previous embodiment, support elements 260a, 260b are movable from an “open” position (FIG. 32) to a “closed” position (FIG. 31). In this embodiment however, elements 260a, 260b are fixed in relation to hinges 265 and no outward or inward sliding motion is experienced.

As indicated above, in FIG. 27 the illustrated cart includes a removable safety strap 290, shown placed around the top of the two buckets being held by the cart. Strap 290 increases the securement of the bucket to the cart and inhibits lateral movement of the bucket, particularly during movement of the cart.

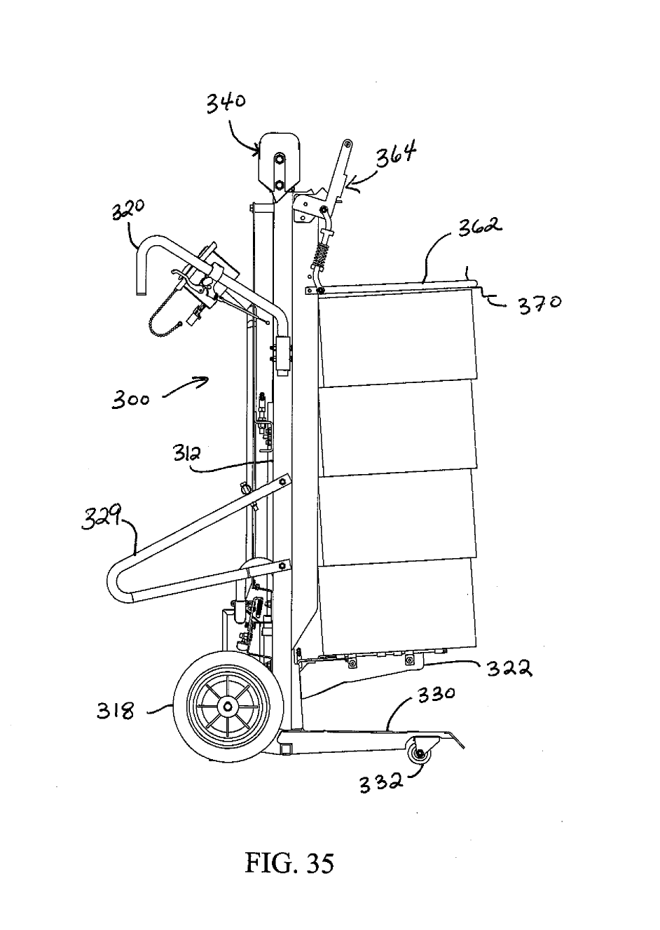

FIGS. 33 through 36A, 36B and 36C are directed to yet another embodiment of a cart, similar to cart 10 and cart 100 in many aspects. Cart 300 of FIGS. 33 through 36A, 36B and 36C includes a retention or retaining bar to stabilize and inhibit shifting of items loaded onto the cart. The retention or retaining bar is an alternative to strap 290 of FIG. 27. Unless indicated, features from carts 10, 100 and other features and elements described above are applicable to cart 300.

Cart 300 has a structural frame 312 with a generally rectangular configuration, having a first end at the bottom of the cart when the cart is in use, and an opposite second end at the top of the cart when the cart is in use, defined by various members, braces and brackets extending vertically and horizontally. Other configurations of frame 312 may alternately be used. Cart 300 includes two primary wheels 318 and a pair of front support arms 330 that support the cart, with or without a load, in an upright position. Optionally, each front support arm may have at least one secondary wheel or caster 332. A handle 320 is present to facilitate tipping and moving of cart 300 by a user. Cart 300 includes an item engagement feature 322 for engaging the sidewall and/or flange of an item such as a bucket; engagement feature 322 is movable along frame 312 by an elevation adjustment mechanism 340. Engagement feature 322 includes a hinged supporting feature 350 configured to support an item by its bottom surface. Supporting feature 350 may be laterally moveable, toward and away from the frame of the cart, or may be laterally fixed in relation to the frame of the cart.

Cart 300 includes a retention bar 360 configured to stabilize and inhibit shifting of items carried by engagement feature 322 or by supporting feature 350. Retention bar 360 includes a retention frame 362 connected to cart frame 312 via a control linkage having an over center linkage 364 by which retention frame 362 can be moved to various positions in relation to frame 312. Retention frame 362, in the illustrated embodiment, has a quasi-circular shape, best seen in FIG. 33; retention frame 362 may have other shapes, including circular, oval, square, pentagonal, hexagonal, octagonal, etc. Present on retention frame 362 is a latch 370, configured to engage with or latch over or onto certain items carried by cart 300. In the illustrated embodiment, latch 370 has a “W” shape, which inhibits latch 370 catching on a bucket when lifting or lower pails on to cart 300 after retention frame 362 has been engaged. Additionally, the W shape is particularly useful for catching sidewalls of a carton (e.g., box) for example, when sudden stops occur or when the cart is tipped up from a tilted-back position.

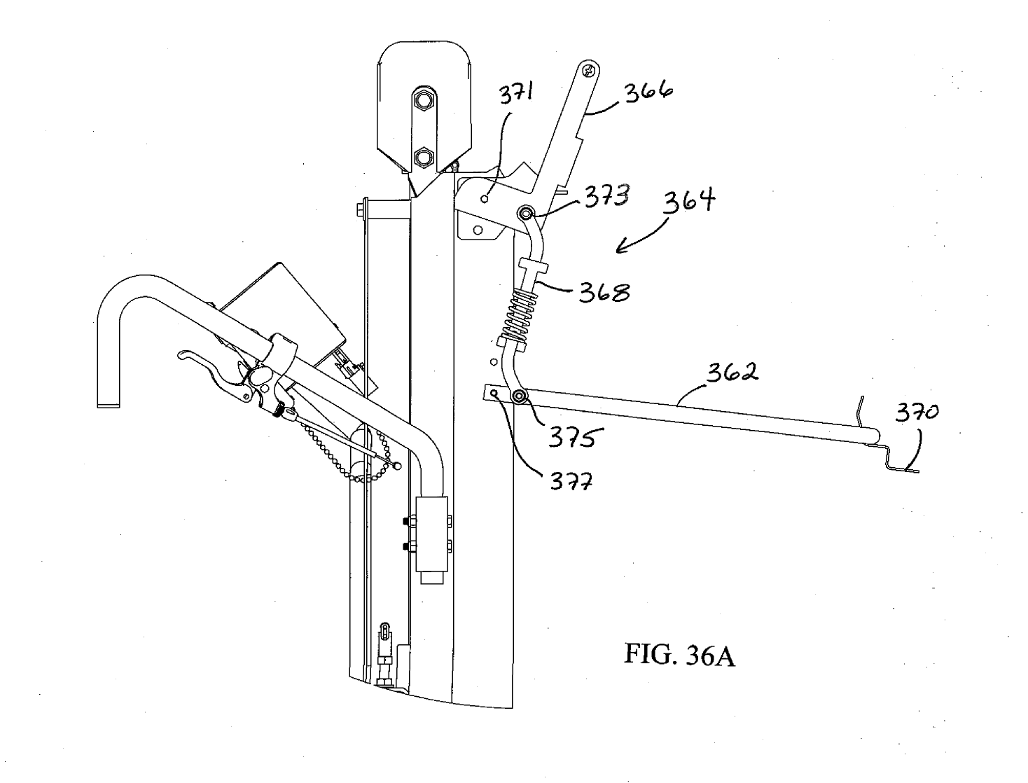

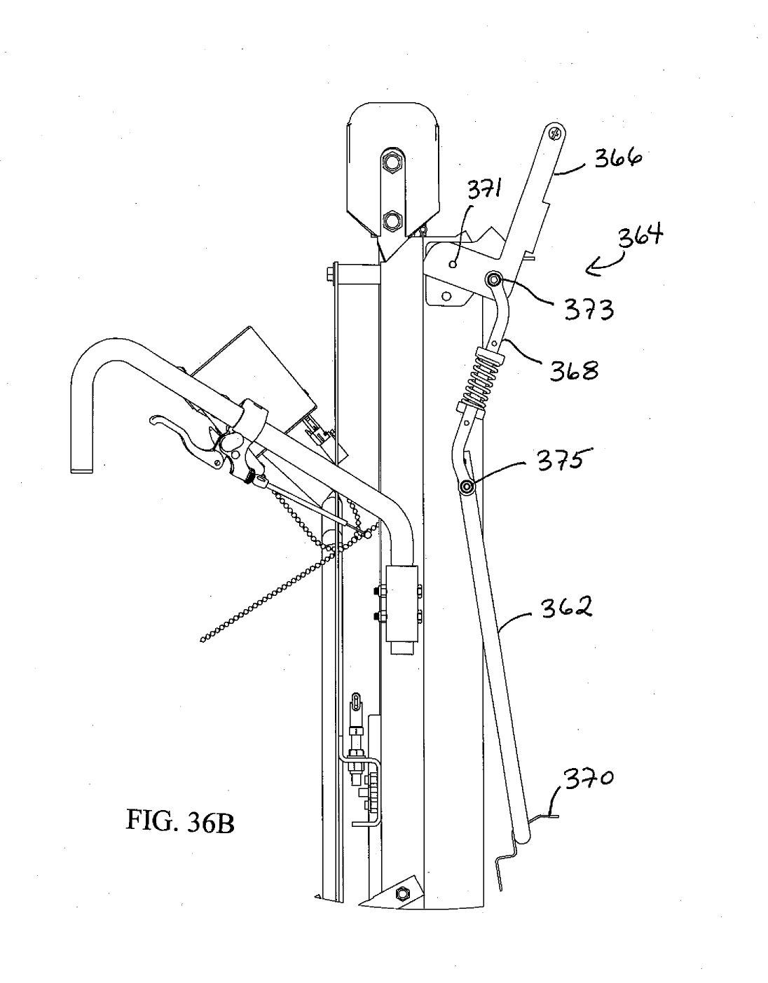

FIGS. 34 and 35 illustrate retention bar 360 engaging a stack of buckets (FIG. 34) and a stack of boxes (FIG. 35). Retention frame 362, with a quasi-circular shape, encircles at least the top bucket of the stack of three buckets being supported by cart 300, thus inhibiting shifting of the stack as cart 300 is moved. Latch 370 on retention frame 362 latches over the top box of the stack of four boxes being supported by cart 300, thus inhibiting shifting of the stack as cart 300 is moved.

The movement of retention frame 362 in relation to frame 312 is produced by control linkage having an over center linkage 364, which includes an actuator 366 and a biased link 368, with actuator 366 pivotally connected to frame 312 at a joint 371 and to biased link 368 at a joint 373, and with biased link 368 further pivotally connected to retention frame 362 at a joint 375. Biased link 368, in the illustrated embodiment, is a spring-loaded link having an adjustable length.

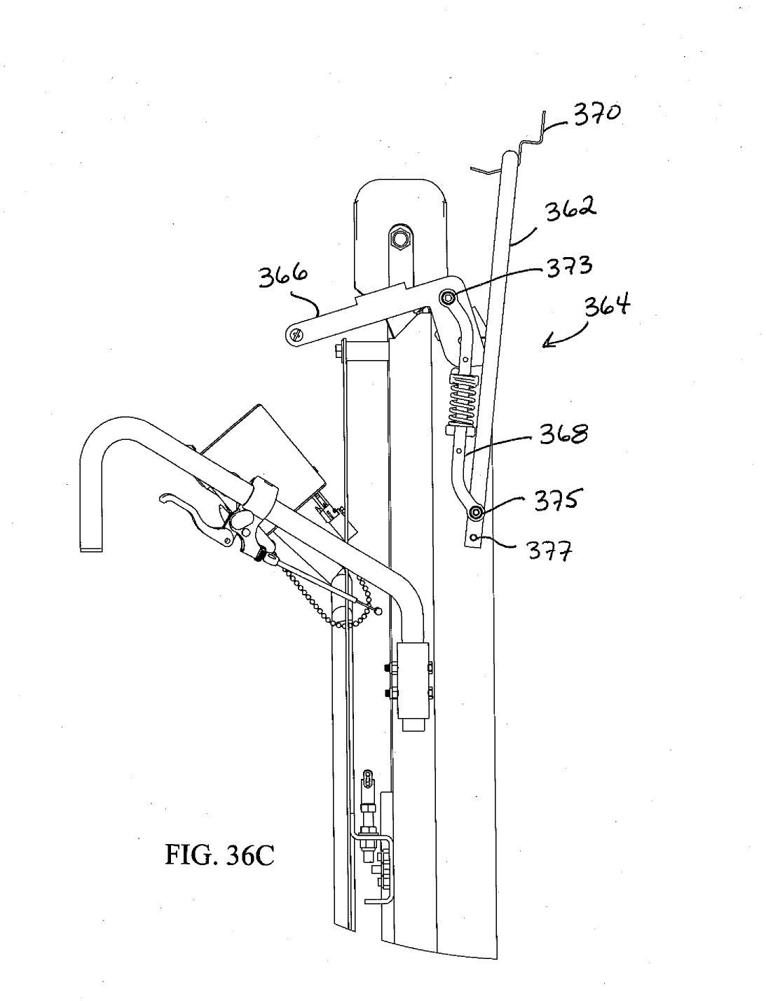

FIGS. 36A, 36B and 36C are enlargements of over center linkage 364 and show three different positions of retention frame 362. In FIG. 36A, frame 362 is positioned in a generally ‘middle’ positioned, as it would be when engaged with a stack of buckets or boxes (see, e.g., FIGS. 34 and/or 35). Retention frame 362 is pivotal about joint 375 to adjust the level of retention frame 362, for example, to engage with taller or lower buckets or boxes. FIG. 36B shows retention frame 362 in a position lower than that of FIG. 36A. To move from the position of FIG. 36A to that of FIG. 36B, retention frame 362 pivots around a point 377.

Another position for retention frame 362 is shown in FIG. 36C, where retention frame 362 is fully upright, out of the way of any items that might be stacked on cart 300. To move from the position of either FIG. 36A or FIG. 36B to the position of FIG. 36C, retention frame 362 pivots around point 377. To lock retention frame 362 in the upright position, actuator 366 is pivoted around joint 371, moving actuator 366 backwards and resulting in biased link 368 and thus retention frame 362 pivoting in an over center manner in relation to actuator 366.

Numerous alternate embodiments of carts and numerous embodiments of features of the carts have been described above. Generally, the carts of this disclosure include any or all of: a frame; a pair of primary wheels; a front support structure supporting at least one caster; an item engagement feature moveably connected to the frame, the engagement feature configured to engage with the sidewall of an item, such as an outwardly extending circumferential flange on a sidewall of a bucket, the engagement feature optionally having a laterally extendable portion; a position adjustment system configured to adjust the position of the engagement feature between the first end and the second end of the frame, the position adjustment system comprising a hydraulic cylinder or a linear actuator; one or more foot levers to control the hydraulic cylinder, optionally one foot lever being a fast elevation adjustment or movement lever and the second foot lever being a slow elevation adjustment or movement lever; a bucket stabilization structure fixed in relation to the frame, such as angled wings or wedges extending parallel to the frame; a release lever operably connected to a reverse switch to change the direction of travel of the engagement feature; a rear stop bar to inhibit backward tipping of the cart; a hand-operated brake operably connected to at least one of the primary wheels; and a battery to actuate the linear actuator. In some embodiments, the item engagement feature may include an element with a support surface to engage with the bottom of an item.

A first particular embodiment of this disclosure is a transport cart comprising a frame having a first wheeled end and a second end, the wheeled end comprising a pair of primary wheels; a front support structure supporting at least one secondary wheel; an engagement feature moveably connected to the frame; a position adjustment system configured to adjust the position of the engagement feature between the first end and the second end of the frame, the position adjustment system comprising a lifting mechanism, the lifting mechanism being a hydraulic cylinder or a linear actuator; one or more foot levers to control the hydraulic cylinder, if a hydraulic cylinder is present; a battery to energize the linear actuator, if a linear actuator is present; and an item stabilization structure fixed in relation to the frame. Other particular embodiments are provided below.

In another embodiment, activation of the one or more foot levers results in movement of the engagement feature.

In another embodiment, the item stabilization structure extends along the frame at least partially between the first end and the second end of the frame.

In another embodiment, the item stabilization structure comprises two angled wings.

In another embodiment, if a hydraulic cylinder is present, the position adjustment system comprises two foot levers to control the hydraulic cylinder.

In another embodiment, the first foot lever is a fast elevation adjustment lever for lighter items and the second foot lever is a slow elevation adjustment lever for heavier items.

In another embodiment, the first foot lever requires a higher foot force to produce elevation adjustment whereas the second foot lever requires a lower foot force to produce elevation adjustment.

In another embodiment, if the lifting mechanism is the hydraulic cylinder, the position adjustment system further comprises a release lever operably connected to a pressure release valve, or, if the lifting mechanism is the linear actuator, the position adjustment system further comprises a reverse switch operably connected to the battery.

In another embodiment, the position adjustment system further comprises a cable connecting the release lever to the reverse switch.

In another embodiment, the item engagement feature is configured to engage with an outwardly extending circumferential flange on a sidewall of a cylindrical item, such as a bucket.

In another embodiment, the item engagement feature comprises an arcuate member.

In another embodiment, the arcuate member comprises two opposing arms.

In another embodiment, the item engagement feature comprises an adjustable portion. If the engagement feature has two arms, a portion of the arms may be inward and outward adjustable.

In another embodiment, the item engagement feature comprises an element configured to engage with a bottom of the item to be lifted.

In another embodiment, the element configured to engage with the bottom is a two-piece element.

In another embodiment, the element, either a two-piece element or a one-piece element, is hingedly moveable in relation to the engagement feature.

In another embodiment, the front support structure comprises two arms, each supporting at least one wheel, the wheel optionally being a caster.

In another embodiment, each of the two arms has an inclined distal end.

In another embodiment, the wheel is positioned proximate the inclined distal end.

In another embodiment, the front support structure is movable in relation to the frame.

In another embodiment, the front support structure forms an angle of 90 to 120 degrees in relation to the frame.

In another embodiment, the cart further comprises a rear stop bar.

In another embodiment, the cart further comprises a hand-operated brake operably connected to at least one of the primary wheels.

In another embodiment, the brake is a friction brake.

In another embodiment, the hand-operated brake is operably connected to both primary wheels.

In another embodiment, the brake is balanced between both primary wheels.

As indicated above, the various carts of this disclosure can be used to lift, transport, and lower items, particularly buckets. An exemplary method of lifting a stack of buckets off of a pallet includes the following steps.

First, as illustrated in FIG. 18, cart 10 is moved into position with support arms 30 under the surface of pallet 80 and with engagement feature 22 engaging the lower bucket. Engagement feature 22 may require movement upwards (i.e., toward top end 16) or downward (i.e., toward bottom end 14) so that upper ledge 27 of engagement feature 22 is positioned under and in contact with an outwardly extending flange or ridge on the bucket. At this step, cart 10 is resting on wheels 18 and casters 32.

Before moving cart 10, either or both foot levers 24, 26 are pumped to raise the buckets off from pallet 80 to a desired level. With the buckets raised, cart 10 can be moved so that support arms 30 withdraw from pallet 80. When tipped, the buckets are stabilized laterally by stabilizing structure 50. Cart 10 can be tipped back any desired amount, lifting casters 32 off of the ground, to roll cart 10 with the buckets to a new location. Alternately, cart 10 may be rolled in an upright position, with all of wheels 18 and casters 32 on the ground.

In the final location, the buckets can be lowered to the ground or another surface (e.g., pallet, bench, shelf) by activating switch 43 via release lever 21 on handle 20 of cart 10.

In some methods, it may not be necessary to activate the position adjustment system of the cart to lift the buckets. Merely tipping the cart back may be sufficient to raise the buckets sufficiently so that it can be moved. Similarly, merely tipping the cart forward may be sufficient to release and deposit the bucket in the desired location.

Thus, various embodiments of the TRANSPORT CART and methods of using the cart are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

1. A transport cart comprising:
a frame having a first wheeled end and a second end, the wheeled end comprising a pair of primary wheels;
a front support structure;
an item engagement feature moveably connected to the frame;
a position adjustment system configured to adjust the position of the engagement feature between the first end and the second end of the frame, the position adjustment system comprising a lifting mechanism, the lifting mechanism being a hydraulic cylinder or a linear actuator;
a first foot lever and a second foot lever to control the hydraulic cylinder, if a hydraulic cylinder is present;
a battery to energize the linear actuator, if a linear actuator is present; and
an elongate item stabilization structure fixed in relation to the frame and extending along the frame at least partially between the first end and the second end of the frame.

2. The cart of claim 1, wherein the item stabilization structure comprises two angled wings.

3. The cart of claim 1, wherein the first foot lever is a fast elevation adjustment lever and the second foot lever is a slow elevation adjustment lever.

4. The cart of claim 3, wherein the first foot lever requires a higher foot force to produce elevation adjustment compared to the second foot lever that requires a lower foot force to produce elevation adjustment.

5. The cart of claim 1, wherein the position adjustment system further comprises:
a release lever operably connected to a pressure release valve if the lifting mechanism is the hydraulic cylinder; or
a reverse switch operably connected to the battery if the lifting mechanism is the linear actuator.

6. The cart of claim 1, wherein the item engagement feature is configured to engage with an outwardly extending circumferential flange on a sidewall of an item.

7. The cart of claim 6, wherein the item engagement feature comprises an arcuate member.

8. The cart of claim 7, wherein the arcuate member comprises two upper opposing arms and a lower support member.

9. The cart of claim 8, wherein the item engagement feature comprises an adjustable portion.

10. The cart of claim 1, wherein the item engagement feature comprises an element configured to engage with a bottom of an item to be lifted.

11. The cart of claim 10, wherein the element configured to engage with the bottom is a two-piece element.

12. The cart of claim 10 wherein the element is hingedly moveable in relation to the engagement feature.

13. The cart of claim 10 wherein the element is slidable towards the frame and away from the frame.

14. The cart of claim 1, wherein the front support structure comprises two arms and supporting at least one wheel or caster.

15. The cart of claim 14, wherein each of the two arms has an inclined distal end.

16. The cart of claim 1 further comprising a rear stop bar.

17. The cart of claim 1 further comprising a hand-operated brake operably connected to at least one of the primary wheels.

18. The cart of claim 17, wherein the brake is a friction brake.

19. The cart of claim 17, wherein the hand-operated brake is operably connected to and balanced between both primary wheels.

20. The cart of claim 1 further comprising a retention bar pivotal in relation to the frame and a control linkage to position the retention bar.

21. The cart of claim 20 where the control linkage bar pivots in an over center manner in relation to the retention bar and the frame.

22. A transport cart comprising:
a frame having a wheeled end comprising a pair of primary wheels;
a front support structure at the wheeled end of the frame, the front support structure comprising two arms, each arm having an inclined distal end;
an arcuate item engagement feature moveably connected to the frame;
a position adjustment system configured to adjust the position of the engagement feature between the first end and the second end of the frame, the position adjustment system comprising a hydraulic cylinder, a first foot lever and a second foot lever operably connected to the hydraulic cylinder, wherein the first foot lever is a fast elevation adjustment lever that requires a higher foot force to produce elevation adjustment compared to the second foot lever, which is a slow elevation adjustment lever that requires a lower foot force to produce elevation adjustment; and
an elongate item stabilization structure fixed in relation to the frame and extending along the frame at least partially between the first end and the second end of the frame.

23. The cart of claim 22, wherein the front support structure comprises at least one wheel or caster.
